(19) United States
(12) Patent Application Publication
(10) Pub. No.: US 2019/0236622 A1
(43) Pub. Date: Aug. 1, 2019

(54) SYSTEMS AND METHODS FOR UTILIZING CROWDSOURCING TO IMPLEMENT ACTIONS

(71) Applicant: Robert Swanson, Spokane, WA (US)

(72) Inventor: Robert Swanson, Spokane, WA (US)

(21) Appl. No.: 16/261,147

(22) Filed: Jan. 29, 2019

Related U.S. Application Data
(60) Provisional application No. 62/623,675, filed on Jan. 30, 2018.

(51) Int. Cl. G06Q 30/02; G06F 3/0482; G06Q 10/06; G06F 16/438; G06F 16/9536; G06T 13/40; G06T 13/80

(52) U.S. Cl. CPC G06Q 30/0203; G06F 3/0482; G06Q 10/06315; G06T 13/80; G06F 16/9536; G06T 13/40; G06F 16/4393

(57) ABSTRACT

This disclosure describes, in part, techniques for utilizing crowdsourcing to implement actions. For instance, a remote system may receive, from an electronic device, data representing a presentation. The remote system may then provide the presentation to a first group of users using a first crowdsourcing resource. While providing the presentation, the remote system may receive feedback for the presentation. Later, the remote system may provide the presentation to a second group of users using a second crowdsourcing resource. While providing the presentation, the remote system may receive additional feedback for the presentation. After receiving the feedback, the remote system may receive data representing a plan for implementing an idea included in the presentation. The plan may be based at least in part on the feedback. The remote system may then provide information associated with the plan to a third group of users so that the idea may be implemented.

### RELATED APPLICATIONS

This application claims priority to U.S. Provisional Patent Application No. 62/623,675, filed Jan. 30, 2018, titled “System and Methods for Using Crowd Sourcing to Leverage Resources into Actions,” the entire contents of which are incorporated herein by reference.

### BACKGROUND

People and businesses utilize crowdsourcing in order to obtain feedback about products and services from a large number of people. For instance, if a business is creating a new product, the business may utilize crowdsourcing in order to obtain feedback about the product, such as whether people find the product to be useful or whether people will purchase the product. To perform the crowdsourcing, the business may send the product to a large number of people and/or post information about the product on a website that is accessible to a large number of people. The business may then receive the feedback for the product.

Even though crowdsourcing has become a widespread technique for receiving feedback for products and services, current systems used for performing crowdsourcing are inadequate for many people, businesses, products, and services. For a first example, the current systems do not provide people and businesses with the ability to target the crowdsourcing to the correct group of people, either based on the types of products/services and/or the locations of the people included in the group. For a second example, the current systems do not provide resources that allow people and businesses to take their products and services from initial ideas, which receive feedback using crowdsourcing, to actionable results that are provided to the public.

### BRIEF DESCRIPTION OF FIGURES

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment that includes a remote system providing resources to a user. The resources may allow the user to at least create a presentation, provide the presentation for crowdsourcing, create a plan for the presentation, and perform an action related to the plan.

FIG. 2 illustrates a block diagram of an example of a remote system that provides resources to users.

FIG. 3 illustrates an example user interface for an avatar that is associated with a user profile and/or presentation.

FIG. 4 illustrates an example user interface of a home page associated with a user profile.

FIG. 5 illustrates an example user interface for viewing answers associated with a presentation.

FIG. 6 illustrates an example user interface for connecting with other users that have provided presentations.

FIG. 7 illustrates a example user interface for searching for presentations and/or user profiles.

FIGS. 8A-8B are an example process for utilizing crowdsourcing resources in order to implement an action.

FIG. 9 is an example process for utilizing multiple resources in order to generate and then implement at least one action included in a presentation.

FIG. 10 is an example process for rating a user profile using feedback received via one or more resources.

### DETAILED DESCRIPTION

This disclosure describes, in part, systems and method for utilizing crowdsourcing to implement actions. For instance, a remote system may provide resources to users that the users can use to create presentations. A presentation may include, but is not limited to, a question, an answer to the question, a product, a service, an idea, a video, music, and/or any other content that may be presented using the presentation. The remote system may additionally provide resources to the users that the users can use to crowdsource their presentations in order to receive feedback. Feedback may include, but is not limited to, a comment, a suggestion, a question, a rating, an intention, information, a request, an additional answer to a question, and/or any other type of feedback that may be provided via crowdsourcing. Furthermore, the remote system may provide resources to the users that the users can use to create plans for implementing actions included in the presentations, as well as resources for providing information to other users when plans are implemented.

For example, the remote system may send, to an electronic device (referred to, in these examples, as a “first electronic device”), data representing a network resource (e.g., a webpage, etc.) that a user (referred to, in these examples, as a “first user”) can use to create a user profile. The user profile may include, but is not limited to, information about the first user, avatar(s) created by the first user, presentation(s) created by the first user, and/or the like. For instance, the first electronic device may receive input indicating the information associated with the first user. The information may include, but is not limited to, an identifier (e.g., name, username, nickname, etc.), contact information (e.g., email address, phone number, home address, etc.), a geographic location (e.g., zip code, city, state, etc.), and/or any other type of information associated with the first user. The first electronic device may additionally receive input indicating information for an avatar being created by the first user. The information may include, but is not limited to, a name, a color, a sex, a height, a weight, physical feature(s), a picture, characteristic(s), and/or the like that describe the avatar. Furthermore, the first electronic device may receive input indicating a presentation being created by the first user. The first electronic device may then send data representing the information to the remote system.

The remote system may receive the data from the first electronic device. The remote system may then use at least a portion of the data to create one or more pages for the user profile. For a first example, the remote system may create a first page (e.g., a “homepage”) that includes the information associated with the first user. For a second example, after generating the avatar using at least a portion of the data, the remote system may create a second page that is associated with the avatar. For instance, the second page may include a rendering of the avatar and/or information describing the avatar. In some instances, the avatar may be associated with the presentation. In such instances, the second page may further include the presentation.

In some instances, the remote system may associate the user profile with a type of membership. The types of membership may include, but are not limited to, a first type of membership that provides the first user with one or more first resources provided by the remote system, a second type of membership that provides the first user with one or more second resources provided by the remote system, a third type of membership that provides the first user with one or more third resources provided by the remote system, and/or so forth. In some instances, the first type of membership may be free to the first user, the second type of membership may cost the first user a first amount of money, the third type of membership may cost the first user a second amount of money, and/or so forth. In some instances, the third type of membership may be associated with businesses.

The resources provided by the remote system may include a first crowdsourcing resource. In some instances, the first crowdsourcing resource may be associated with “testing” the presentation in order to receive feedback from a first group of users. For instance, the remote system may provide the presentation to the first group of users using the first crowdsourcing resource. In some instances, to provide the presentation, the remote system may add the presentation to a network resource, such as webpage, that includes one or more additional presentations that the first group of users can view and/or provided feedback. For instance, while the presentation is provided using the first crowdsourcing resource, the remote system may receive, from one or more electronic device associated with one or more users included in the first group of users, data representing feedback for the presentation. The remote system may then store the feedback in association with the user profile and/or the presentation. Additionally, in some instances, the remote system may send, to the first electronic device, at least a portion of the data representing the feedback.

In some instances, the remote system may use the feedback to rate the presentation. In some instances, the rating may be between a range, such as zero and ten, although other ranges may be used by the remote system. For a first example of rating the presentation, if the remote system receives positive feedback for the presentation, the remote system may increase the rating for the presentation and, if the remote system receives negative feedback for the presentation, the remote system may decrease the rating for the presentation. For a second example of rating the presentation, the feedback may include scores that are within the range (e.g., scores between zero and ten). The remote system may then rate the presentation as the average of the scores, the median of the scores, the mode of the scores, and/or using any other technique.

In some instances, the remote system may present, within the first crowdsourcing resource, the presentations according to the ratings. For a first example, the remote system may present the presentation with the first highest rating first, present the presentation with the second highest rating second, present the presentation with the third highest rating third, and/or so forth. For a second example, if a user within the first group of users is searching through presentations included in the first crowdsourcing resource, the remote system may send, to an electronic device of the user, data representing the presentation with the first highest rating, followed by data representing the presentation with the second highest rating, followed by data representing the presentation with the third highest rating, and/or so forth. As such, and in such examples, presentations that include higher ratings may be viewed by more users included in the first group of users and/or receive more feedback from the users included in the first group of users.

In some instances, the first group of users may be able to view the feedback for the presentation. For instance, the remote system may provide at least a portion of the feedback using the network resource. When providing the feedback, the remote system may present the feedback using one or more factors. For a first example, the remote system may present positive feedback for the presentation before presenting negative feedback for the presentation. For a second example, the remote system may rate feedback for the presentation, such as using similar techniques as discussed above for the presentations (e.g., using additional feedback that is received for the feedback). The remote system may then present the feedback based on the ratings. For instance, the remote system may present feedback that includes a higher rating before presenting feedback that includes a lower rating. For a third example, the remote system may present the feedback according to times at which the feedback was received by the remote system. For instance, the remote system may present feedback that was recently received by the remote system before presenting feedback that was received further in the past.

In some instances, the remote system may provide search functionality for searching for presentations included in the first crowdsourcing resource. For example, each presentation may include content (e.g., one or more words included in the presentation) and/or may include one or more tags that describe the presentation, such as a type of presentation (e.g., question, response, product, service, etc.), a location associated with the presentation, an age group of users that may find the presentation interesting, an identity of the user that created the presentation, and/or any other type of tag that indicates information for the presentation. The remote system may then use the content and/or the tags for the presentations to provide a user with results when the user is performing a search for specific presentations.

For a first example, the remote system may receive, from an electronic device, data representing one or more words associated with a search query. The remote system may then match the one or more words to tags associated with presentations. For instance, if a word includes a location, such as Spokane, then the remote system may match the location with tags of presentations that also include Spokane. Based on the matches, the remote system may send, to the electronic device, data representing the identified presentations. For a second example, the remote system may receive, from an electronic device, data representing one or more filters selected by a user. The remote system may then match the one or more filters to tags associated with presentations. For instance, if a filter includes a location, such as Spokane, then the remote system may match the location with tags of presentations that also include Spokane. Based on the matches, the remote system may send, to the electronic device, data representing the identified presentations.

In some instances, a user may select more than one filter when performing a search. For example, the remote system may receive, from an electronic device, data representing at least two filters selected by the user. The remote system may then match each of the filters to tags associated with presentations. For instance, if a first filter includes a location, such as Spokane, and a second filter includes a type of presentation, such as questions, then the remote system may match the location with tags of first presentations that also include Spokane and then match the type of presentations with tags of the first presentations that also include questions. Based on the matches, the remote system may send, to the electronic device, data representing the identified presentations. While these are just a couple of examples of a user performing a search, in other examples, the remote system may use any other technique to provide users with the ability to search for presentations.

In some instances, the first crowdsourcing resource may be associated with a particular first group of users. For example, the first crowdsourcing resource may be associated with users located in a specific geographic area (e.g., zip code, city, state, etc.), users that include a specific age range, users that include similar interests (e.g., helping the environment, vehicles, sports, etc.), and/or the like. In some instances, the first user creating the presentation may select the first crowdsourcing resource for providing the presentation based on the particular group of users. For instance, the first user may indicate the geographic area that is associated with the presentation. The remote system may then provide the presentation using the first crowdsourcing resource that is associated with the geographic area.

In some instances, the remote system may generate a group that includes one or more users from the first group of users, and then associate the presentation with the group. For a first example, the remote system may generate the group to include users that have provided feedback for the presentation. For a second example, the remote system may generate the group to include users that have requested to join the group. In some instances, the group may include a group leader. For example, the group leader may include the first user that created the presentation. In some instances, the remote system may provide the group with resources for communicating with one another to discuss the presentation, such as with a collaborative session in which the users included in the group are able to provide additional feedback for the presentation. Still, in some examples, the remote system may generate contact(s) for the user(s) included in the group and associate the contact(s) with the user profile of the first user. The first user may then use the contact(s) to communicate with the user(s).

After the first user has received feedback using the first crowdsourcing resource, the first user may determine whether to update the presentation based on the feedback. For example, if the presentation includes a question and an answer, the first user may update the answer based on the feedback received using the first crowdsourcing resource. The first user may then determine to use one or more additional resources provided by the remote system to receive additional feedback for the presentation.

For instance, the first user may decide to use a second crowdsourcing resource provided by the remote system to receive additional feedback for the presentation (which may have been updated). In some instances, the second crowdsourcing resource is associated with a second group of users. For example, the first group of users may include users that include the first type of membership and the second group of users may include users that include the second type of membership and/or the third type of membership. As such, the second group of users may include one or more different users than the first group of users.

In some instances, and as partially discussed above, the first crowdsourcing resource may be associated with “testing” the presentation in order to receive initial feedback associated with idea(s) (e.g., the question, the answer, etc.) included in the presentation. For instance, the initial feedback may indicate to the first user whether the presentation includes a good presentation, which the first user should consider advancing using the second crowdsourcing resource, or whether the presentation includes a bad presentation, which the first user should cease from advancing. The second crowdsourcing resource may then be associated with implementing the idea(s) included in the presentation. For instance, the second crowdsourcing resource may be associated with receiving feedback about how to implement the idea(s), feedback about whether there are better idea(s) (e.g., answers) for the presentation, and/or the like. Additionally, the second crowdsourcing resource may be used to generate a group for implementing the presentation, which is discussed in more detail below.

To use the second crowdsourcing resource, the remote system may provide the presentation to the second group of users using the second crowdsourcing resource. In some instances, to provide the presentation, the remote system may add the presentation to a network resource, such as a webpage, that includes one or more additional presentations that the second group of users can view and/or provide additional feedback. For instance, while the presentation is provided using the second crowdsourcing resource, the remote system may receive, from one or more electronic device associated with one or more users included in the second group of users, data representing the additional feedback for the presentation. The remote system may then store the feedback in association with the user profile and/or the presentation. Additionally, in some instances, the remote system may send, to the first electronic device associated with the first user, at least a portion of the data representing the additional feedback.

In some instances, the remote system may use the additional feedback to rate the presentation. In some instances, and similar to the rating above, the rating may be between a range, such as zero and ten, although other ranges may be used by the remote system. For a first example of rating the presentation, if the remote system receives additional feedback for the presentation that is positive, the remote system may increase the rating for the presentation and, if the remote system receives additional feedback for the presentation that is negative, the remote system may decrease the rating for the presentation. For a second example of rating the presentation, the additional feedback may include scores that are within the range (e.g., scores between zero and ten). The remote system may then rate the presentation as the average of the scores, the median of the scores, the mode of the scores, and/or using any other technique.

In some instances, the remote system may present, within the second crowdsourcing resource, the presentations according to the ratings. For a first example, the remote system may present the presentation with the first highest rating first, present the presentation with the second highest rating second, present the presentation with the third highest rating third, and/or so forth. For a second example, if a user within the first group of users is searching through presentations included in the second crowdsourcing resource, the remote system may send, to an electronic device of the user, data representing the presentation with the first highest rating, followed by data representing the presentation with the second highest rating, followed by data representing the presentation with the third highest rating, and/or so forth. As such, and in such examples, presentations that include higher ratings may be viewed by more users included in the second group of users and/or receive more additional feedback from the users included in the second group of users.

In some instances, the second group of users may be able to view the additional feedback for the presentation. For instance, the remote system may provide at least a portion of the additional feedback using the network resource. When providing the additional feedback, the remote system may present the additional feedback using one or more factors. For a first example, the remote system may present positive additional feedback for the presentation before presenting negative additional feedback for the presentation. For a second example, the remote system may rate the additional feedback for the presentation, such as by using similar techniques as discussed above for the presentations. The remote system may then present the additional feedback based on the ratings. For a third example, the remote system may present the additional feedback according to times at which the additional feedback was received by the remote system. For instance, the remote system may present additional feedback that was recently received by the remote system before presenting additional feedback that was received further in the past.

In some instances, the remote system may provide search functionality for searching for presentations included in the second crowdsourcing resource. For example, and as discussed above, each presentation may include content and/or one or more tags that describe the presentation, such as a type of presentation (e.g., question, response, product, service, etc.), a location associated with the presentation, an age group of users that may find the presentation interesting, an identity of the user that created the presentation, and/or any other type of tag that indicates information for the presentation. The remote system may then use the content and/or the tags for the presentations to provide a user with results when the user is performing a search for specific presentations.

For a first example, the remote system may receive, from an electronic device, data representing one or more words associated with a search query. The remote system may then match the one or more words to tags associated with presentations. Based on the matches, the remote system may send, to the electronic device, data representing the identified presentations. For a second example, the remote system may receive, from an electronic device, data representing one or more filters selected by a user. The remote system may then match the one or more filters to tags associated with presentations. Based on the matches, the remote system may send, to the electronic device, data representing the identified presentations. While these are just a couple of examples of a user performing a search, in other examples, the remote system may use any other technique to provide users with the ability to search for presentations.

In some instances, the second crowdsourcing resource may be associated with a particular second group of users. For example, the second crowdsourcing resource may be associated with users located in a specific geographic area (e.g., zip code, city, state, etc.), users that include a specific age range, users that include similar interests (e.g., helping the environment, vehicles, sports, etc.), and/or the like. In some instances, the first user creating the presentation may select the second crowdsourcing resource for providing the presentation based on the particular group of users. For instance, the first user may indicate the geographic area that is associated with the presentation.

In some instances, the remote system may generate a group that includes one or more users from the second group of users, and then associate the presentation with the group. For a first example, the remote system may generate the group to include users that have provided additional feedback for the presentation. For a second example, the remote system may generate the group to include users that have requested to join the group. In some instances, the group may include a group leader. For example, the group leader may include the first user that created the presentation. In some instances, the remote system may provide the group with resources for communicating with one another to discuss the presentation, such as with a collaborative session in which the users included in the group are able to provide additional feedback for the presentation. Still, in some examples, the remote system may generate contact(s) for the user(s) included in the group and associate the contact(s) with the user profile of the first user. The first user may then use the contact(s) to communicate with the user(s).

In some instances, users included in the group are able to monitor the progress of the presentation. For a first example, the remote system may provide the users with the additional feedback for the presentation. For a second example, if the first user uses the additional feedback to further update the presentation, the remote system may provide the users with the updates. Still, for a third example, if the presentation includes a question with a first answer, and an additional user provides a second answer for the question, then the remote system may provide the users with the second answer. In such an example, the users included in the group may determine whether the first answer or the second answer includes a better approach to the question. Additionally, in such an example, the first user may determine whether to update the first answer based on the second answer and/or feedback that is received for the second answer.

After receiving the additional feedback, the first user may use one or more resources provided by the remote system to create a plan for implementing idea(s) included in the presentation (also referred to as implementing an action of the presentation). For instance, if the presentation includes a question and an answer, where the answer is an idea for solving a problem of the question, then the plan may be for implementing the idea (e.g., solving the problem). When creating the plan, the remote system may receive, from electronic device(s) of user(s) included in the second group of users and/or the generated group, (1) data representing plans for implementing the idea, (2) data representing ratings for the presentation, (3) data representing suggestions for implementing the plan, (4) data representing promises to support the presentation, (5) data representing a project statement for implementing the idea included in the presentation, and/or (6) data representing feedback for the product statement. The remote system may then generate the plan using at least a portion of the received data.

The first user may then use one or more resources provided by the remote system to “activate” the presentation. In some instances, to “activate” the presentation, the remote system may provide information to the generated group, where the information is associated with the plan created to implement the idea(s) included in the presentation. For example, if the presentation is associated with a response to clean a river in a geographic area, then the plan for cleaning the river may include (s) a specific location to meet along the river, (2) a given time for meeting, and (3) that cleaning the river includes picking up trash that is located along the river. As such, the information may include the specific location along the river, the given time for meeting, and that to clean the river users are going to pick up the trash that is located along the river. In some instances, providing the information may include adding the information to a network resource, such as a webpage, that is accessible to the generated group. In some instances, providing the information may include sending, to electronic device(s) of user(s) included in the generated group, data representing the information.

In some instances, the remote system may allow the first user to use the resources described above when creating multiple avatars and/or presentations. For example, the first user may create multiple avatars and associate individual avatars with one or more presentations. The remote system may then allow the first user to advance the presentations through the resources, as described above. In other words, the remote system may provide the first user with the ability to quickly and efficiently “test” multiple presentations created by the first user. Based on the testing, the first user may select one or more of the presentations for creating plans and/or performing actions associated with the plans. For instance, the first user may select the presentations that received the best feedback.

In some instances, the remote system may generate a network resource, such as a webpage, that includes one or more avatars created by one or more other users. The first user may then use the network resource to view other avatar(s) created by the other user(s). For instance, the first electronic device may receive an input selecting an avatar. The remote system may then receive, from the first electronic device, data representing the selection of the avatar. In response, the remote system may send, to the first electronic device, data representing information associated about the avatar, which the first electronic device may display to the user. The information may include, but is not limited to, an image of the avatar, presentation(s) associated with the avatar, group(s) which the avatar is associated with, rating(s) associated with the avatar, presentation(s) that the avatar has indicated an interest in, and/or any other type of information associated with the avatar.

In some instances, the remote system may allow the first user to “link” a created avatar and/or presentation with one or more other avatars and/or presentations. For example, the first user may select another presentation for which the first user wants to link the created presentation. Based on the selection, the remote system may generate an association between the first user's presentation and the selected presentation. In some instances, the remote system may generate a network resource, such as a webpage, that includes the association between the first user's presentation and the selected presentation. The network resource may indicate why the first user created the association between the presentation, such that the presentations are similar (e.g., include a same type of presentation, are directed to similar subject matter, etc.) In such instances, other users can view the network resource and provide feedback for the association. For instance, the other users may rate the association of the presentations. The remote system may then determine an overall rating for the association and provide the overall rating via the network resource.

In some instances, the remote system stores data that allows the remote system to generate the resources for the users. For example, the remote system may receive, from an electronic device, data representing a request to generate a new first resource. Based on the data, the remote system may use the stored data to quickly generate the first resource for the user. In some examples, the new resource may include a generic resource, and the user may then customize features included in the new resource. For example, the user may customize graphics, text, groups, and/or the like. In some examples, the new resource is specific to the user. For example, the data received from the electronic device may indicate the customized features and the remote system may generate the new resource to already include the customized features.

In some instances, the first user may associate resources (and/or avatars) with the user profile and/or the avatar created by the first user. For example, the first user may have an interest in a resource, such as a crowdsourcing resource that is specific to a geographic area. The remote system may then receive, from the first electronic device, data representing a selection to associate the resource with the user profile and/or the avatar. In response, the remote system may generate a link (e.g., a Uniform Resource locator, etc.) to the resource and add the link to the user profile and/or the network resource associated with the avatar. As such, later when the user wants to view the resource, the user may use the link to quickly find the resource. In some instances, when searching for resources, the first user may be provided with a row of links that have been created for the first user. The first user can then quickly search through identified resources using the row of links.

As discussed herein, in some instances, a group may include a public group, which users can join upon request, or private groups, which users can join once authorized. For instance, when creating a private group, the remote system may receive, from electronic device(s), data representing request(s) to join the group. The remote system may then allow the user(s) to join the group once the user(s) are authorized. For instance, the first user that created the presentation and/or the group may need to authorize the user(s) before the user(s) are able to join the group.

By providing a remote system that includes resources for generating a presentation, crowdsourcing the presentation using multiple crowdsourcing resources, generating a plan for implementing idea(s) included in the presentation, and providing information for performing the plan, the remote system includes improvements over other systems used for crowdsourcing. For instance, the remote system is able to use data (e.g., feedback) received using a first of the resources in order to further advance the presentation using the other resources. For a first example, the remote system may use the feedback received from the first crowdsourcing resource when identifying the second group of people to provide the presentation using the second crowdsourcing resource. For a second example, the remote system is able to use the feedback received using the crowdsourcing resources when generating the plan for implementing the idea(s) included in the presentation. By synchronizing the data between the various resources, the remote system generates a better plan for implementing the idea(s).

Additionally, other systems used for crowdsourcing do not create relevancy and collaboration. As a result, the other systems fail to adequately provide crowdsourcing for ideas. In contrast, the remote system provides ease of access to an easily understood organization of resources and users with knowledge, and creates collaboration between the users in order to receive adequate feedback for presentations.

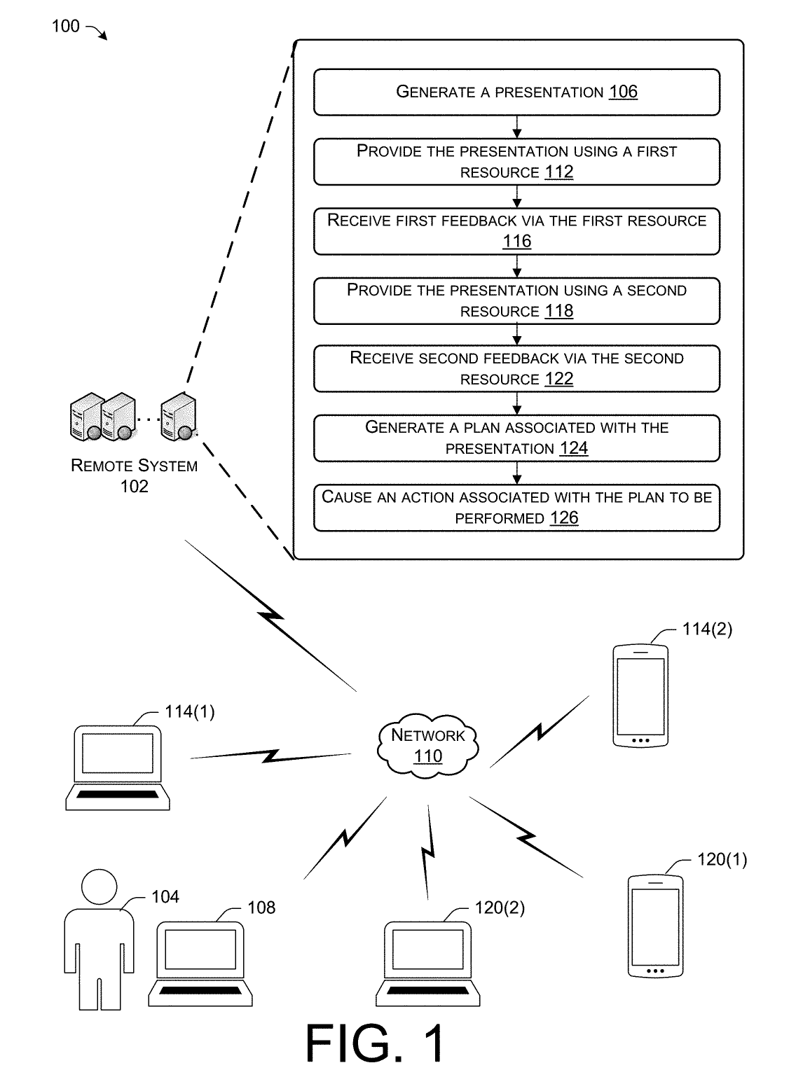

FIG. 1 illustrates an example environment 100 that includes a remote system 102 providing resources to a first user 104. The resources may allow the first user 104 to at least create a presentation, provide the presentation for crowdsourcing, create a plan for the presentation, and perform an action related to the plan.

For instance, at operation 106, the remote system 102 may generate a presentation. For example, the remote system 102 may send, to a first electronic device 108 and over a network 110, data representing a network resource (e.g., a webpage, etc.) that the first user 104 can use to create a user profile and/or a presentation. For instance, the first electronic device 108 may receive, from the first user 104, input indicating information associated with the first user 104. The information may include, but is not limited to, an identifier (e.g., name, username, nickname, etc.), contact information (e.g., email address, phone number, home address, etc.), a geographic location (e.g., zip code, city, state, etc.), and/or any other type of information associated with the first user 104. The first electronic device 108 may additionally receive, from the user 108, input indicating information for an avatar being created by the first user 104. The information may include, but is not limited to, a name, a color, a sex, a height, a weight, physical feature(s), a picture, characteristic(s), and/or the like associated with the avatar.

Furthermore, the first electronic device 108 may receive, from the first user 104, input indicating information associated with a presentation being created by the first user 104. As discussed herein, the presentation may include, but is not limited to, a question, a response to the question, a product, a service, an idea, a video, music, and/or any other content that may be presented using the presentation. For instance, and in the example of FIG. 1, the information may include a question, such as “How can we clean the Spokane River?”. Additionally, the information may include an answer to the question, such as “Get five hundred users together, on October 19, at Maple Street Bridge, to walk along the Spokane River to pick the trash up”. The first electronic device 108 may then send, over the network 110, data representing the information to the remote system 102.

The remote system 102 may receive, over the network 110, the data from the first electronic device 108. The remote system 102 may then use at least a portion of the data to create one or more pages for the user profile. For a first example, the remote system 102 may create a first page (e.g., a homepage) that includes the information associated with the first user 104. For instance, the first page may include the identifier, the contact information, the geographic location, and/or the like associated with the first user 104. For a second example, the remote system 102 may create a second page that includes a rendering of the avatar, as generated using the data, as well as information related to the avatar.

Additionally, the remote system 102 may use at least a portion of the data to generate the presentation for the first user 104. For instance, the presentation may include the question created by the first user 104, such as “How can we clean the Spokane River?”. Additionally, the presentation may include the answer created by the user, such as “Get five hundred users together, on October 19, at Maple Street Bridge, to walk along the Spokane River to pick the trash up”. In some instances, the remote system 102 may then associate the presentation with the avatar. For instance, the remote system 102 may add the presentation to the second page that includes the rendering of the avatar.

At operation 112, the remote system 102 may provide the presentation using a first resource. For example, the remote system 102 may determine that the user profile is associated with a first type of membership. The first type of membership may allow the first user 104 to receive feedback using the first resource. In some instances, the first type of membership is free to the first user 104.

In the example of FIG. 1, the first resource may include a first crowdsourcing resource. In some instances, the first crowdsourcing resource may be associated with “testing” the presentation in order to receive feedback from a first group of users. For instance, the remote system 102 may provide the presentation to the first group of users using the first crowdsourcing resource. In some instances, to provide the presentation, the remote system 102 may add the presentation to a network resource, such as webpage, that includes one or more additional presentations that the first group of users can view and/or provide feedback. Additionally, or alternatively, in some instances, to provide the presentation, the remote system 102 may send, over the network 110, data representing the presentation to at least a second electronic device 114(1) and a third electronic device 114(2). The second electronic device 114(1) may be associated with a second user included in the first group of users and the third electronic device 114(2) may be associated with a third user included in the first group of users.

At operation 116, the remote system 102 may receive first feedback via the first resource. For example, while the presentation is being provided using the first crowdsourcing resource, the remote system 102 may receive, over the network 110 and from the second electronic device 114(1) and the third electronic device 114(2), data representing the first feedback for the presentation. The remote system 102 may then store the first feedback in association with the user profile. Additionally, in some instances, the remote system 102 may send, to the first electronic device 108 and over the network 110, at least a portion of the data representing the first feedback.

In the example of FIG. 1, the first feedback received from the second electronic device 114(1) may be positive, such as “That response to the question sounds great to me”. Additionally, the first feedback received from the third electronic device 114(2) may by positive, but also provide a new answer for the question, such as “That is a real problem, but I think we will need one thousand users in order to clean up the Spokane River”. In some instances, the remote system 102 may provide the first feedback to other users included in the first group of users. In such instances, the remote system 102 may provide the first feedback using one or more factors, which are described herein.

In some instances, the remote system 102 may generate a group that includes one or more users from the first group of users, and then associate the presentation with the group. For a first example, the remote system 102 may generate the group to include users that have provided first feedback for the presentation, such as the second user associated with the second electronic device 114(1) and the third user associated with the third electronic device 114(2). For a second example, the remote system 102 may generate the group to include users that have requested to join the group. For instance, the remote system 102 may receive, from the second electronic device 114(1) and/or the third electronic device 114(2), data representing a request to join the group. The remote system 102 may then generate the group to include the second user and/or the third user.

In some instances, the group may include a group leader. For example, the group leader may include the first user 104 that created the presentation. In some instances, the remote system 102 may provide the group with resources for communicating with one another to discuss the presentation, such as with a collaborative session in which the users included in the group are able to provide additional feedback for the presentation. For instance, the first user 104 may use the resources to communicate with the second user associated with the second electronic device 114(1) and/or the third user associated with the third electronic device 114(2). In some instances, the remote system 102 may provide the users included in the group with updates to the presentation. For instance, if the first user 104 updates the presentation, then the remote system 102 may send, to the second electronic device 114(1) and/or the third electronic device 114(2), and over the network 110, data representing the update. As such, the users included in the group can monitor the progress of the presentation.

For instance, after the first user 104 has received the first feedback using the first crowdsourcing resource, the first user 104 may determine whether to update the presentation based on the first feedback. For instance, and in the example of FIG. 1, the first user 104 may use the first feedback received from the third electronic device 114(2) to update the presentation to include “one thousand users”. As such, the presentation may include a new answer to the question, such as “Get one thousand users together, on October 19, at Maple Street Bridge, to walk along the Spokane River to pick the trash up”. The remote system 102 may then provide the users included in the group with the updated presentation.

At operation 118, the remote system 102 may provide the presentation using a second resource. In some instances, such as if the user profile is associated with the first type of membership, and before providing the presentation using the second resource, the first user 104 may have to update the membership from the first type of membership to the second type of membership. The second type of membership may allow users to provide presentations using the second resource. To update the membership, the remote system 102 may receive, from the first electronic device 108 and over the network 110, data representing a request to update the membership to the second type of membership. The remote system 102 may then use the data to associate the user profile with the second type of membership.

In the example of FIG. 1, the second resource may include a second crowdsourcing resource. In some instances, the second crowdsourcing resource may be associated with receiving “global” feedback for the presentation by receiving additional feedback from a second group of users. For instance, the remote system 102 may provide the presentation to the second group of users using the second crowdsourcing resource. In some instances, to provide the presentation, the remote system 102 may add the presentation to a network resource, such as webpage, that includes one or more additional presentations that the second group of users can view and/or provide feedback. Additionally, or alternatively, in some instances, to provide the presentation, the remote system 102 may send, over the network 110, data representing the presentation to at least a fourth electronic device 120(1) and a fifth electronic device 120(2). The fourth electronic device 120(1) may be associated with a fourth user included in the second group of users and the fifth electronic device 122(2) may be associated with a fifth user included in the second group of users.

At operation 122, the remote system 102 may receive second feedback via the second resource. For example, while the presentation is being provided using the second crowdsourcing resource, the remote system 102 may receive, over the network 110 and from the fourth electronic device 120(1) and the fifth electronic device 120(2), data representing the second feedback for the presentation. The remote system 102 may then store the second feedback in association with the user profile. Additionally, in some instances, the remote system 102 may send, to the first electronic device 108 and over the network 110, at least a portion of the data representing the second feedback.

In the example of FIG. 1, the second feedback received from the fourth electronic device 120(1) may be positive, such as “That response to the question would work great”. Additionally, the second feedback received from the fifth electronic device 120(2) may by positive, but also include a rating for the response, such as “That is a real problem, and this seems like a great solution, I rate this a ten”. In some instances, the remote system 102 may provide the second feedback to other users included in the second group of users. In such instances, the remote system 102 may provide the second feedback using one or more factors, which are described herein.

In some instances, the remote system 102 may generate a group that includes one or more users from the second group of users, and then associate the presentation with the group. For a first example, the remote system 102 may generate the group to include users that have provided feedback for the presentation, such as the fourth user associated with the fourth electronic device 120(1) and a fifth user associated with a fifth electronic device 120(2). For a second example, the remote system 102 may generate the group to include users that have requested to join the group. For instance, the remote system 102 may receive, from the fourth electronic device 120(1) and/or the fifth electronic device 12-(2), data representing a request to join the group. The remote system 102 may then generate the group to include the fourth user and/or the fifth user.

In some instances, the group may include a group leader. For example, the group leader may include the first user 104 that created the presentation. In some instances, the remote system 102 may provide the group with resources for communicating with one another to discuss the presentation, such as with a collaborative session in which the users included in the group are able to provide additional feedback for the presentation. For instance, the first user 104 may use the resources to communicate with the fourth user associated with the fourth electronic device 120(1) and the fifth user associated with the fifth electronic device 120(2).

After the first user 104 has received the second feedback using the second crowdsourcing resource, the first user 104 may determine whether to again update the presentation based on the second feedback. After the first user 104 determines that the presentation is complete, the first user 104 and/or users included in the generated group may create a plan for implementing idea(s) included in the presentation. For instance, the first user 104 may generate a plan for implementing the answer to the question that is included in the presentation.

For instance, at operation 124, the remote system 102 may generate a plan associated with the presentation. For example, the remote system 102 may provide the first user 104 with a network resource, such as a webpage, for creating the plan. In some instances, to provide the network resource, the remote system 102 may send, to the first electronic device 108 and over the network 110, data representing the network resource. The first electronic device 108 may then receive, from the first user 104, input indicating the plan for implanting the answer. For instance, the input may indicate: (1) at least one thousand users getting together, (2) a meeting date of October 19, (3) a meeting location of Maple Street Bridge, and (4) an action that includes walking along the Spokane River picking up trash. The first electronic device 108 may then send, to the remote system 102 and over the network 110, data representing the plan.

The remote system 102 may receive the data from the first electronic device 108 and generate the plan using at least a portion of the data. For instance, the remote system 102 may generate the plan to include: (1) at least one thousand users getting together, (2) a meeting date of October 19, (3) a meeting location of Maple Street Bridge, and (4) an action that includes walking along the Spokane River picking up trash. The remote system 102 may then associate the plan with the user profile. After creating the plan, the first user 104 may use the remote system 102 to put the plan into action.

For instance, at operation 126, the remote system 102 may cause an action associated with the plan to be performed. In some instances, to cause the action to be performed, the remote system 102 may provide the plan using a third network resource, such as a website. The network resource may be accessible to users included in the second group of users and/or one or more of the generated groups. For instance, the network resource may be accessible to the fourth user and the fifth user. In some instances, to cause the action to be performed, the remote system 102 may send data representing the plan to one or more users. In some instances, the one or more users may include users included in the second group of users and/or the generated group. For instance, the remote system 102 may send, over the network, the data representing the plan to the fourth electronic device 120(1) and the fifth electronic device 120(2).

In some instances, after the action associated with the plan occurs, the remote system 102 may receive data representing feedback about the action. For instance, the feedback may indicate whether the action was successful, whether the action was unsuccessful, whether a new action is being planned, and/or any other type of feedback. The remote system 102 may then provide the feedback to one or more users. For instance, the remote system 102 may provide the feedback to the users included in the second group of users and/or the generated group.

Additionally, in some instances, the remote system 102 may use the feedback to provide recommendations to other users that are creating other presentations. For instance, if another use is creating another presentation about cleaning up a river, the remote system 102 may use the feedback for the presentation to determine that the action was successful. As such, the remote system 102 may provide the other user a suggestion that is based on the performed action. For instance, the suggestion may indicate that the other user should use at least one thousand users to perform the cleaning.

Although the above example includes the user 104 creating a single presentation, in other examples, the user 104 may perform a similar process to create more than one presentation. For example, the user 104 may create two or more presentations. The remote system 102 may then provide the two or more presentations using the first resource. The first group of users may then provide feedback for each of the presentations. Based on the feedback, the user 104 may determine whether advance each of the two or more presentations through the rest of the process. For example, the user 104 may select a first presentation and a second presentation from the two or more presentation. In some instances, the first presentation and the second presentation may have received the most positive feedback from the first group of users.

The remote system 102 may then provide the first presentation and the second presentation to the second group of users using the second resource. While providing the presentations, the remote system 102 may receive, from the second group of users, feedback for both the first presentation and the second presentation. The first user 104 may then use the feedback to determine whether to advance at least one of the first presentation or the second presentation. For example, if the first presentation received better feedback (e.g., a better rating) than the second presentation, then the first user 104 may determine to advance the first presentation. The first user 104 may then generate a plan for the first presentation and/or cause an action associated with the plan to be performed.

In other words, the remote system 102 may allow the first user 104 to “test” more than one presentation using the first resource. The first user 104 may then use the feedback received from the first group of users to determine whether to advance one or more of the presentations. The remote system 102 then allows the first user 104 to “test” the one or more selected presentations using the second resource. The first user 104 may then use the feedback received from the second group of users to determine whether to advance one or more of the selected presentations. In this way, the first user 104 may be better informed when determining which presentation to advance to the last resource included in the process.

In some instances, the remote system 102 may “restart” feedback for a presentation as the first user 104 advances the presentation through the resources. For example, and as discussed above, the presentation may receive first feedback using the first resource. Based on the first feedback, the remote system 102 may determine a first rating for the presentation and associate the presentation with the first rating. If the first user 104 then determines to advance the presentation by providing the presentation using the second resource, then the remote system 102 may no longer associate the presentation with the first rating. Rather, the remote system 102 remote system 102 may determine a second rating for the presentation using second feedback and associate the presentation with the second rating. By “restarting” the feedback, the presentation may not be affected by a bad rating received using the first resource. As such, an initial bad rating for the presentation may not later hurt the presentation as the first user 104 advances the presentation.

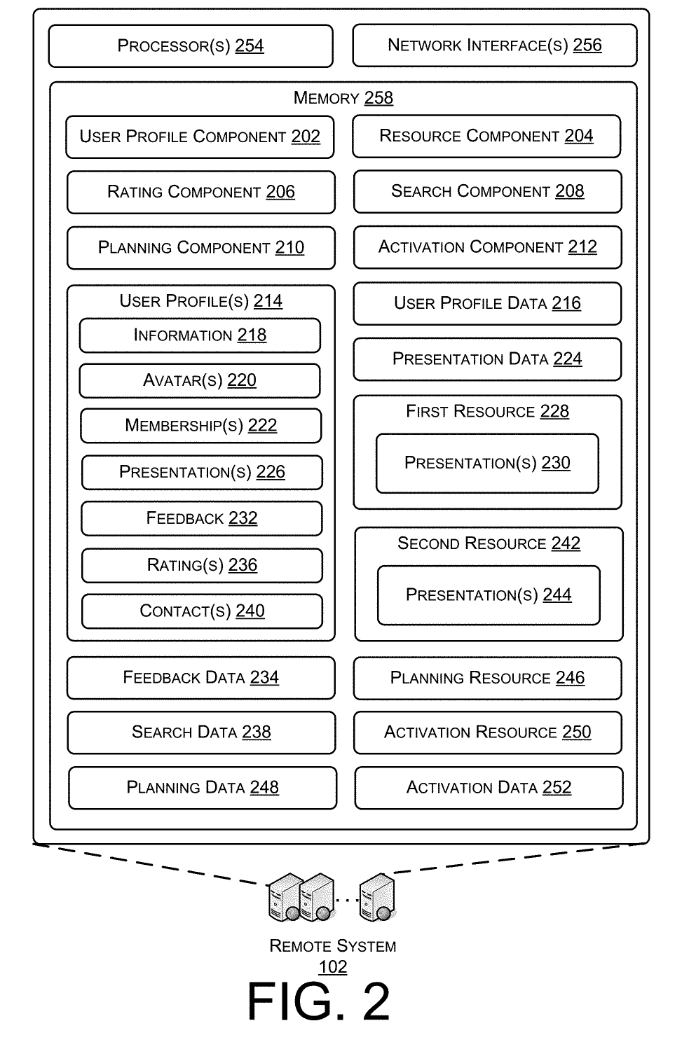

FIG. 2 illustrates a block diagram of an example of the remote system 102 that provides resources to users. As shown in the example of FIG. 2, the remote system 102 includes at least a user profile component 202, a resource component 204, a rating component 206, a search component 208, a planning component 210, and an activation component 212. In other examples, the remote system 102 may include one or more additional components not illustrated in FIG. 2. Additionally, or alternatively, in some instances, the remote system 102 may not include one or more of the components illustrated in FIG. 2.

The user profile component 202 may be configured to generate user profile(s) 214 for user(s) that utilize the remote system 102. For instance, the remote system 102 may receive user profile data 216 from an electronic device (referred to, in these examples, as the “first electronic device”) associated with a user (referred to, in these examples, as the “first electronic device”) (e.g., the first electronic device 108 associated with the first user 104). The user profile data 216 may represent information about the first user, such as, but not limited to, an identifier (e.g., name, username, nickname, etc.), contact information (e.g., email address, phone number, home address, etc.), a geographic location (e.g., zip code, city, state, etc.), and/or any other type of information associated with the first user. The user profile data 216 may further represent information for creating an avatar, such as, but not limited to, a name, a color, a sex, a height, a weight, physical feature(s), a picture, characteristic(s), and/or other attributes associated with the avatar.

The user profile component 202 may then use the user profile data 216 to generate a user profile 214. For instance, the user profile component 202 may generate the user profile 214 to include information 218 about the first user, which the remote system 102 retrieves from the user profile data 216. Additionally, the user profile component 202 may use the user profile data 216 to generate an avatar 220 for the user profile. For instance, the user profile component 202 may generate the avatar 220 to include the name, the color, the sex, the height, the weight, the physical feature(s), the picture, the characteristic(s), and/or the other attributes included in the user profile data 216. In some instances, the user profile component 202 may generate a network resource, such as a webpage, for the avatar. For instance, other users may be able to view the avatar using the network resource.

In some instances, the user profile component 202 may associate the user profile 214 with one or more memberships 222. As discussed herein, a first type of membership 222 may provide the first user with one or more first resources provided by the remote system 102, a second type of membership 222 may provide the first user with one or more second resources provided by the remote system 102, a third type of membership 222 may provide the first user with one or more third resources provided by the remote system 102, and/or so forth. In some instances, the first type of membership may be free to the user, the second type of membership may cost the first user a first amount of money, the third type of membership may cost the first user a second amount of money, and/or so forth. In some instances, the third type of membership may be associated with businesses.

The remote system 102 may further receive, from the first electronic device, presentation data 224 representing a presentation 226 being created by the first user. As discussed herein, the presentation 226 may include, but is not limited to, a question, an answer to the question, a product, a service, an idea, a video, music, and/or any other content that may be presented. The user profile component 202 may use the presentation data 224 to generate the presentation 226. In some instances, the user profile component 202 may then associate the presentation 226 with the avatar 220. For instance, the user profile component 202 may add the presentation 226 to the network resource associated with the avatar 220.

The resource component 204 may be configured to provide the presentation 226 using a first resource 228, which includes one or more other presentations 230. In some instances, the first resource 228 may include a first crowdsourcing resource associated with “testing” the presentation 226 in order to receive feedback 232 from a first group of users. For instance, while the presentation 226 is being provided using the first resource 228, the remote system 102 may receive, from one or more electronic devices associated with one or more users included in the first group of users, presentation data 224 representing the feedback 232 for the presentation 226. The remote system 102 may then store the feedback 232 in association with the user profile 214. Additionally, in some instances, the remote system 102 may send, to the first electronic device, at least a portion of the feedback data 234 representing the feedback 232.

In some instances, the rating component 206 may be configured to use the feedback 232 to create a rating 236 for the presentation 226. In some instances, the rating 236 may be between a range, such as zero and ten, although other ranges may be used by the remote system 102. For a first example of rating the presentation 226, if the remote system 102 receives positive feedback 232 for the presentation 226, the remote system 102 may increase the rating 236 for the presentation 226 and, if the remote system 102 receives negative feedback for the presentation 226, the remote system 102 may decrease the rating 236 for the presentation 226. For a second example of rating the presentation 226, the feedback 232 may include scores that are within the range (e.g., scores between zero and ten). The remote system 102 may then create the rating 236 for the presentation 226 as the average of the scores, the median of the scores, the mode of the scores, and/or using any other technique.

In some instances, the resource component 204 may present, within the first resource 228, the presentation(s) 230 according to the ratings. For a first example, the resource component 204 may present the presentation 230 with the first highest rating first, present the presentation 230 with the second highest rating second, present the presentation 230 with the third highest presentation third, and/or so forth. For instance, the presentation 230 with the highest rating may be presented at a top of a list of the presentations 230, the presentation 230 with the second highest rating may be presented below the presentation 230 with the highest rating, the presentation 230 with the third highest rating may be presented below the presentation 230 with the second highest rating, and/or so forth. Additionally, or alternatively, the presentation with the highest rating may be presented at a left position in a list of the presentations 230, the presentation 230 with the second highest rating may be presented to the right of the presentation 230 with the highest rating, the presentation 230 with the third highest rating may be presented to the right of the presentation 230 with the second highest rating, and/or so forth.

For a second example, if a user within the first group of users is searching through presentations included in the first resource 228, the remote system 102 may send, to an electronic device of the user, presentation data 224 representing the presentation 230 with the first highest rating, followed by presentation data 224 representing the presentation 230 with the second highest rating, followed by presentation data 224 representing the presentation 230 with the third highest presentation, and/or so forth. As such, and in such examples, presentation(s) 230 that include higher ratings may be viewed by more users included in the first group of users and/or receive more feedback from the users included in the first group of users.

In some instances, the first group of users may be able to view the feedback 232 for the presentation 230. For instance, the resource component 204 may provide at least a portion of the feedback 232 using a network resource (e.g., the first resource 228). When providing the feedback 232, the resource component 204 may present the feedback 232 using one or more factors. For a first example, the resource component 204 may present positive feedback 232 for the presentation 226 before presenting negative feedback 232 for the presentation 226. For a second example, the rating component 206 may rate the feedback 232 for the presentation 226, such by using similar techniques as discussed above for the presentation(s) 230 (e.g., using additional feedback 232 that is received for the feedback 232). The resource component 204 may then present the feedback 232 based on the ratings.

In some instances, the resource component 204 may allow the first user that created the presentation 226 to remove at least a portion of the feedback 232. For a first example, if the feedback 232 includes offensive feedback 232, then the resource component 204 may remove the feedback 232. For a second example, the remote system 102 may receive, from the first electronic device, data representing a request to remove feedback 232. In some instances, the request may indicate why the feedback 232 is to be removed, such that the feedback 232 includes offensive language. Based on the data, the resource component 204 may remove the feedback 232.

In some instances, the search component 208 is configured to provide search functionality for searching for presentation(s) 230 included in the first resource 228. For example, each presentation 230 may include content and/or one or more tags that describe the presentation 230, such as a type of presentation 230 (e.g., question, response, product, service, etc.), a location associated with the presentation 230, an age group of users that may find the presentation 230 interesting, an identity of the user that created the presentation 230, and/or any other type of tag that indicates information for the presentation 230. The search component 208 may then use the tags for the presentation(s) 230 to provide a user with results when the user is performing a search for specific presentation(s) 230.

For a first example, the remote system 102 may receive, from an electronic device, search data 238 representing one or more words associated with a search query. The search component 208 may then match the one or more words to tags associated with presentation(s) 230. For instance, if a word includes a location, such as Spokane, then the search component 208 may match the location with tags of presentation(s) 230 that also include Spokane. Based on the matches, the remote system 102 may send, to the electronic device, presentation data 224 representing the identified presentation(s) 230.

For a second example, the remote system 102 may receive, from an electronic device, search data 238 representing one or more filters selected by a user. The search component 208 may then match the one or more filters to tags associated with the presentation(s) 230. For instance, if a filter includes a location, such as Spokane, then the search component 208 may match the location with tags of presentation(s) 230 that also include Spokane. Based on the matches, the remote system 102 may send, to the electronic device, presentation data 224 representing the identified presentation(s) 230. While these are just a couple of examples of performing a search, in other examples, the remote system 102 may use any other technique to provide users with the ability to search for presentation(s) 230.

In some instances, the remote system 102 may associate the first resource 228 with a particular first group of users. For example, the remote system 102 may associate the first resource 228 with users located in a specific geographic area (e.g., zip code, city, state, etc.), users that include a specific age range, users that include similar interests (e.g., helping the environment, vehicles, sports, etc.), users that speak a specific language, and/or the like. In some instances, the user creating the presentation 226 may select the first resource 228 for providing the presentation 226 based on the particular group of users. For instance, the first user may indicate the geographic area that is associated with the presentation 226. The remote system 102 may then provide the presentation 226 using the first resource 228 that is associated with the geographic area.

In some instances, the remote system 102 may generate a group that includes one or more users from the first group of users, and then associate the presentation 226 with the group. For a first example, the remote system 102 may generate the group to include users that have provided feedback 232 for the presentation 226. For a second example, the remote system 102 may generate the group to include users that have requested to join the group. In some instances, the group may include a group leader. For example, the group leader may include the first user that created the presentation 226. In some instances, the remote system 102 may provide the group with resources for communicating with one another to discuss the presentation 226, such as with a collaborative session in which the users included in the group are able to provide additional feedback 232 for the presentation 226.

For example, the remote system 102 may generate contact(s) 240. A contact 240 may include an identifier (e.g., name, username, nickname, etc.) of a user, contact information (e.g., email address, phone number, home address, link to user profile 214, etc.) for the user, a geographic location (e.g., zip code, city, state, etc.) of the user, and/or any other type of information associated with the user. In some instances, the remote system 102 generates a contact 240 for individual users that are included in the generated group. Additionally, or alternatively, in some instances, the remote system 102 generates a contact 240 based on receiving, from the first electronic device, data representing a request to create the contact 240. In some instances, the contact(s) 240 are associated with the avatar 220 and/or the presentation 226. For instance, the remote system 102 may add the contact(s) 240 to the network resource associated with the avatar 220.

The first user can then use the contact(s) 240 to communicate with other user(s). For instance, the remote system 102 may receive, from the first electronic device of the first user, data representing a message for another user. The remote system 102 may then send, to an additional electronic device of the other user, the data representing the message. In other words, the remote system 102 provides network resources for allowing the users to communicate, such as to discuss the presentation 226.

In some instances, the remote system 102 may receive, from the first electronic device, presentation data 224 representing an update to the presentation 226. For instance, the first user may use the feedback 232 received via the first resource 228 to update information included in the presentation 226, where the presentation data 224 represents the updated information. The user profile component 202 may then use the presentation data 224 to update the presentation 226. For instance, the user profile component 202 may update the information included in the presentation 226.

The resource component 204 may further be configured to provide the presentation 226 (which may have been updated) using a second resource 242, which may include one or more additional presentations 244. In some instances, the second resource 242 may include a second crowdsourcing resource associated with receiving additional feedback 232 for the presentation 226 and/or implementing the presentation 226. The second resource 242 may be associated with a second group of users. For example, the first group of users may include users that include the first type of membership 222 and the second group of users may include users that include the second type of membership 222 and/or the third type of membership 222. As such, the second group of users may include one or more different users than the first group of users.

While the presentation 226 is being provided using the second resource 242, the remote system 102 may receive, from one or more electronic devices associated with one or more users included in the second group of users, feedback data 234 representing the additional feedback 232 for the presentation 226. The remote system 102 may then store the additional feedback 232 in association with the user profile 214. Additionally, in some instances, the remote system 102 may send, to the first electronic device associated with the first user that created the presentation 226, at least a portion of the feedback data 234 representing the additional feedback 232.

In some instances, the rating component 206 may be configured to use the additional feedback 232 to create a rating 236 for the presentation 226, using similar techniques to those discussed above. Additionally, the resource component 204 may present, within the second resource 242, the presentation(s) 244 according to the ratings. For a first example, the resource component 204 may present the presentation 244 with the first highest rating first, present the presentation 244 with the second highest rating second, present the presentation 244 with the third highest presentation third, and/or so forth. For instance, the presentation 244 with the highest rating may be presented at a top of a list of the presentations 244, the presentation 244 with the second highest rating may be presented below the presentation 244 with the highest rating, the presentation 244 with the third highest rating may be presented below the presentation 244 with the second highest rating, and/or so forth. Additionally, or alternatively, the presentation with the highest rating may be presented at a left position in a list of the presentations 244, the presentation 244 with the second highest rating may be presented to the right of the presentation 244 with the highest rating, the presentation 244 with the third highest rating may be presented to the right of the presentation 244 with the second highest rating, and/or so forth.

For a second example, if a user within the second group of users is searching through presentation(s) 244 included in the second resource 242, the remote system 102 may send, to an electronic device of the user, presentation data 224 representing the presentation 244 with the first highest rating, followed by presentation data 224 representing the presentation 244 with the second highest rating, followed by presentation data 224 representing the presentation 244 with the third highest presentation, and/or so forth. As such, and in such examples, presentation(s) 244 that include higher ratings may be viewed by more users included in the second group of users and/or receive more feedback from the users included in the second group of users.

In some instances, the second group of users may be able to view the additional feedback 232 for the presentation 226. For instance, the remote system 102 may provide at least a portion of the additional feedback 232 using a network resource (e.g., the second resource 242). When providing the additional feedback 232, the remote system 102 may present the additional feedback 232 using one or more factors. For a first example, the remote system 102 may present positive feedback 232 for the presentation 226 before presenting negative feedback 232 for the presentation 226. For a second example, the rating component 206 may rate the additional feedback 232 for the presentation 226, such as by using similar techniques as discussed above for the presentation(s) 230 (e.g., using additional feedback 232 that is received for the feedback 232). The remote system 102 may then present the additional feedback 232 based on the ratings.

In some instances, the resource component 204 may allow the first user that created the presentation 226 to remove at least a portion of the feedback 232. For a first example, if the feedback 232 includes offensive feedback 232, then the resource component 204 may remove the feedback 232. For a second example, the remote system 102 may receive, from the first electronic device, data representing a request to remove feedback 232. In some instances, the request may indicate why the feedback 232 is to be removed, such that the feedback 232 includes offensive language. Based on the data, the resource component 204 may remove the feedback 232.

In some instances, the search component 208 is configured to provide search functionality for searching for presentation(s) 244 included in the second resource 242. For example, and as discussed above, each presentation 244 may include content and/or one or more tags that describe the presentation 244, such as a type of presentation 244 (e.g., question, response, product, service, etc.), a location associated with the presentation 244, an age group of users that may find the presentation 244 interesting, an identity of the user that created the presentation 244, and/or any other type of tag that indicates information for the presentation 244. The search component 208 may then use the tags for the presentation(s) 244 to provide a user with results when the user is performing a search for specific presentation(s) 244.

For a first example, the remote system 102 may receive, from an electronic device, search data 238 representing one or more words associated with a search query. The search component 208 may then match the one or more words to tags associated with presentation(s) 244. For instance, if a word includes a location, such as Spokane, then the search component 208 may match the location with tags of presentation(s) 244 that also include Spokane. Based on the matches, the remote system 102 may send, to the electronic device, presentation data 224 representing the identified presentation(s) 244.

For a second example, the remote system 102 may receive, from an electronic device, search data 238 representing one or more filters selected by a user. The search component 208 may then match the one or more filters to tags associated with the presentation(s) 244. For instance, if a filter includes a location, such as Spokane, then the search component 208 may match the location with tags of presentation(s) 244 that also include Spokane. Based on the matches, the remote system 102 may send, to the electronic device, presentation data 224 representing the identified presentation(s) 244. While these are just a couple of examples of performing a search, in other examples, the remote system 102 may use any other technique to provide users with the ability to search for presentation(s) 244.

In some instances, the remote system 102 may associate the second resource 242 with a particular first group of users. For example, the remote system 102 may associate the second resource 242 with users located in a specific geographic area (e.g., zip code, city, state, etc.), users that include a specific age range, users that include similar interests (e.g., helping the environment, vehicles, sports, etc.), and/or the like. In some instances, the first user creating the presentation 226 may select the second resource 242 for providing the presentation 226 based on the particular group of users. For instance, the first user may indicate the geographic area that is associated with the presentation 226. The remote system 102 may then provide the presentation 226 using the second resource 242 that is associated with the geographic area.

In some instances, the remote system 102 may generate a group that includes one or more users from the second group of users, and then associate the presentation 226 with the group. For a first example, the remote system 102 may generate the group to include users that have provided additional feedback 232 for the presentation 226. For a second example, the remote system 102 may generate the group to include users that have requested to join the group. In some instances, the group may include a group leader. For example, the group leader may include the first user that created the presentation 226. In some instances, the remote system 102 may provide the group with resources for communicating with one another to discuss the presentation 226, such as with a collaborative session in which the users included in the group are able to provide additional feedback 232 for the presentation 226. In some instances, the remote system 102 may generate contact(s) 240 for the user(s) included in the group.

In some instances, the remote system 102 may receive, from the first electronic device, presentation data 224 representing an update to the presentation 226. For instance, the first user may use the additional feedback 232 received via the second resource 242 to update information included in the presentation 226, where the presentation data 224 represents the updated information. The user profile component 202 may then use the presentation data 224 to update the presentation 226. For instance, the user profile component 202 may update the information included in the presentation 226.

The resource component 204 may further be configured to provide the first user with a planning resource 246 for creating a plan to implement idea(s) included in the presentation 226. In some instances, the planning resource 246 may include a network resource, such as a webpage, that the first user can use to create the plan. In some instances, the planning resource 246 further provides the first user with the ability to communicate with other user(s), such as user(s) included in the generated groups, to create the plan. For instance, when providing the presentation 226 using the planning resource 246, the remote system 102 may receive, from one or more electronic devices, planning data 248 representing the plan for implementing the idea(s) included in the presentation 226. For instance, the planning data 248 may include at least (1) data representing plans for implementing the idea, (2) data representing ratings for the presentation, (3) data representing suggestions for implementing the plan, (4) data representing promises to support the presentation, (5) data representing a project statement for implementing the idea included in the presentation, and/or (6) data representing feedback for the product statement.

The planning component 210 may then be configured to generate the plan for the presentation 226. After creating the plan, the resource component 204 may be configured to provide the first user with an activation resource 250 for “activating” the plan. For instance, the activation resource 250 may include a network resource, such as a webpage, that includes the plan. The first user may then use the network resource to verify that the plan is correct. Once verified, the remote system 102 may receive, from the first electronic device, activation data 252 representing a request to activate the plan.

The activation component 212 may then be configured to “activate” the plan for presentation 226. In some instances, to “activate” the plan for the presentation 226, the activation component 212 may send, to electronic device(s) of user(s), activation data 252 representing information associated with the plan created to implement the presentation 226. For example, if the presentation 226 is associated with an answer on how to clean a river in a geographic area, then the plan for cleaning the river may include (1) a specific location to meet along the river, (2) a given time for meeting, and (3) that cleaning the river includes picking up trash that is located along the river. As such, the information may include the specific location along the river, the given time for meeting, and that to clean the river users are going to pick up the trash that is located along the river. Additionally, or alternatively, in some instances, to “activate” the plan for the presentation 226, the activation component 212 may provide the plan using the activation resource 250.

In some instances, the resource component 204 may further provide users with resources for conducting transactions. For a first example, if the first user wants to update the membership 222 from the first type of membership 222 to the second type of membership 222, the remote system 102 may receive, from the first electronic device, data representing payment information (e.g., a name, a card number, a zip code, a bank account number, etc.). The remote system 102 may then use the payment information to process a transaction of a cost of updating the membership. In some instances, to process the transaction, the remote system 102 may communicate with a payment processing service and/or one or more computing devices associated with one or more banks.

For a second example, if another user wants to send money to the first user in order to help fund the presentation 226, then the remote system 102 receive, from an electronic device, data representing payment information associated with the other user. Additionally, the remote system 102 may receive, from the first electronic device, data representing payment information associated with the first user. The remote system 102 may then use the payment information to transfer an amount of money from an account associated with the other user to an account associated with the first user. In other words, the first user may use the payment information to engage a third party to transfer the amount of money from the account associated with the other user to the account associated with the first user.

As further illustrated in FIG. 2, the remote system 102 includes processor(s) 254, network interface(s) 256, and memory 258. As used herein, a processor, such as the processor(s) 254, may include multiple processors and/or a processor having multiple cores. Further, the processors may comprise one or more cores of different types. For example, the processors may include application processor units, graphic processing units, and so forth. In one instance, the processor may comprise a microcontroller and/or a microprocessor. The processor(s) 254 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, the processor(s) 254 may possess its own local memory, which also may store program components, program data, and/or one or more operating systems.

The memory 258 may include volatile and nonvolatile memory, removable and non-removable media implemented in any method or technology for storage of information, such as computer-readable instructions, data structures, program component, or other data. The memory 324 and/or the memory 406 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory 258 may be implemented as computer-readable storage media (“CRSM”), which may be any available physical media accessible by the processor(s) 254 to execute instructions stored on the memory 258. In one basic instance, CRSM may include random access memory (“RAM”) and Flash memory. In other instances, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as the memory 258, discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon.com Inc. of Seattle, Wash., USA; the Windows operating system from Microsoft Corporation of Redmond, Wash., USA; LynxOS as promulgated by Lynx Software Technologies, Inc. of San Jose, Calif.; Operating System Embedded (Enea OSE) as promulgated by ENEA AB of Sweden; and so forth.

The network interface(s) 256 may enable the remote system 102 to send data to and/or receive data from other electronic device(s). The network interface(s) 256 may include one or more network interface controllers (NICs) or other types of transceiver devices to send and receive data over the network. For instance, the network interface(s) 256 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, the network interface(s) 256 may include a wide area network (WAN) component to enable message over a wide area network.

The operations and/or functionalities associated with and/or described with respect to the components of the remote system 102 may be performed utilizing cloud-based computing resources. For example, web-based systems such as Elastic Compute Cloud systems or similar systems may be utilized to generate and/or present a virtual computing environment for performance of some or all of the functionality described herein. Additionally, or alternatively, one or more systems that may be configured to perform operations without provisioning and/or managing servers, such as a Lambda system or similar system, may be utilized.

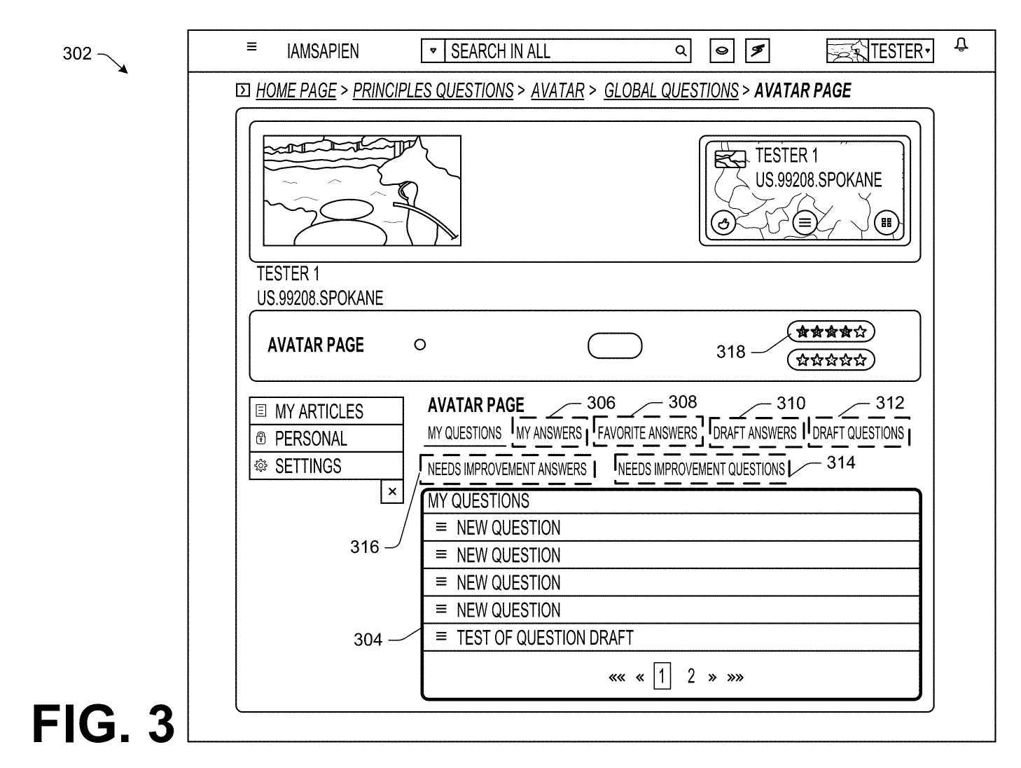

FIG. 3 illustrates an example user interface 302 of an avatar 220 associated with a user profile. As shown, a user may use the user interface 302 to create at least one presentation 226. For instance, the user interface 302 includes a portion 304 for creating new questions. In some instances, the remote system 102 may then associate the questions with the avatar 220. Additionally, and as further shown in FIG. 3, the user interface 302 include a graphical element 306 that is selectable to view answers (e.g., MY ANSWERS”), a graphical element 308 that is selectable to view favorite answers (e.g., “FAVORITE ANSWERS”), a graphical element 310 that is selectable to view draft answers (e.g., “DRAFT ANSWERS”), a graphical element 312 that is selectable to view draft questions (e.g., “DRAFT QUESTIONS”), a graphical element 314 that is selectable to view questions that need more improvement (e.g., “NEEDS IMROVEMENT QUESTIONS”), and a graphical element 316 that is selectable to view answers that need improvement (e.g., “NEEDS IMROVEMENT ANSWERS”).

Additionally, the user interface 302 includes a rating 318 (which may include a rating 236) for the avatar 220 and/or the presentation 226. In some instances, the rating 318 may be based on feedback 232 received about the avatar 220 and/or one or more presentations 226 associated with the avatar 220. Additionally, or alternatively, in some instances, the rating 318 may be based on feedback 232 received about the user that created the avatar 220 and/or feedback 232 received about the user profile 214. In some instances, the remote system 102 continues to update the rating 318 as additional feedback 232 is received.

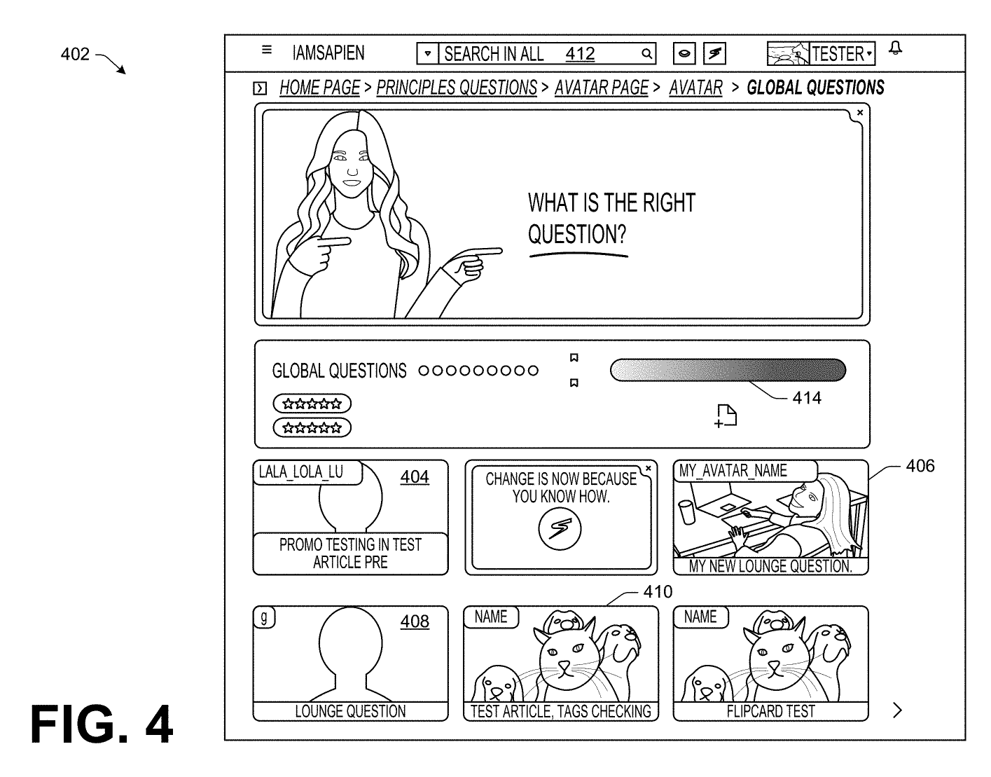

FIG. 4 illustrates an example user interface 402 of a home page associated with a user profile 214. As shown, the user interface 402 includes at least a graphical element 404 that is selectable to provide the presentation 226 using the first resource 228 (e.g., test the presentation 226), a graphical element 406 that is selectable to view avatar 220 information and/or the user interface 302, a graphical element 408 that is selectable to view other presentations 226 included in a lounge, and a graphical element 410 that is selectable to provide the presentation 226 using the second resource 242.

Additionally, the user interface 402 includes a graphical element 412, such as a search bar, that the user can use to perform one or more of the searches described herein. For instance, in the example of FIG. 4, the user may use the graphical element 412 to input one or more words associated with a search.

As further illustrated in FIG. 4, the user interface 402 includes a color bar 414 that the user can use to associate an avatar and/or the user profile with a specific color. In some instances, the color may be based on the mood of the user. In some instances, the color may be based on the type of presentation that is associated with the avatar. In some instances, the color is used when other users are searching for avatars and/or presentations.

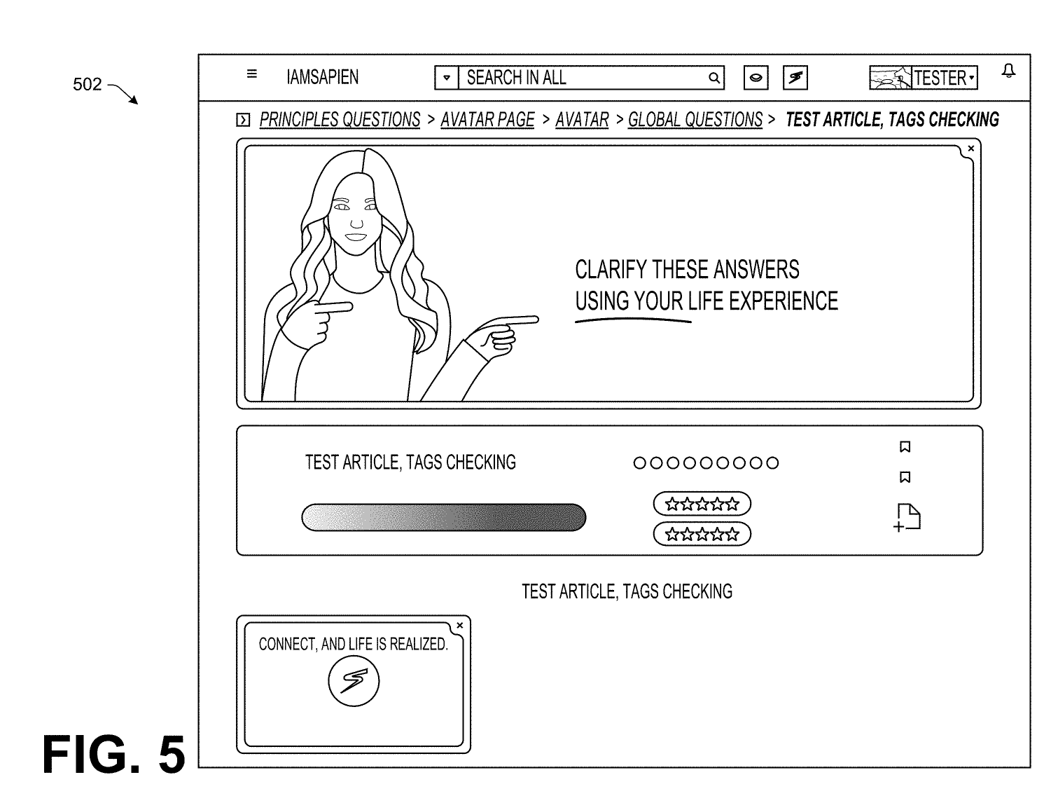

FIG. 5 illustrates an example user interface 502 for viewing answers associated with a presentation 226. For instance, the user may use the user interface 502 to find, connect, value, comments, and organize answers for the presentations 226.

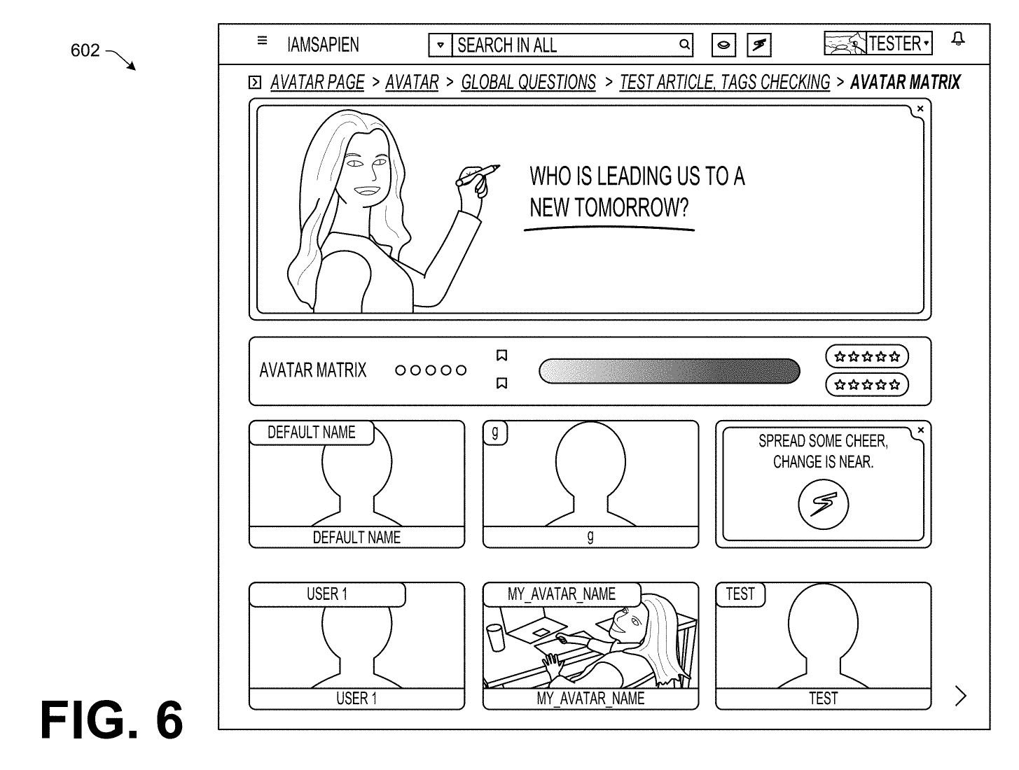

FIG. 6 illustrates an example user interface 602 for connecting with other users that have provided presentations 226. For instance, the user may use the user interface 602 to search for other users that include similar interests as the user. The user may further use the user interface 602 to view presentations 226 of the users, such as answers that have been submitted by the users.

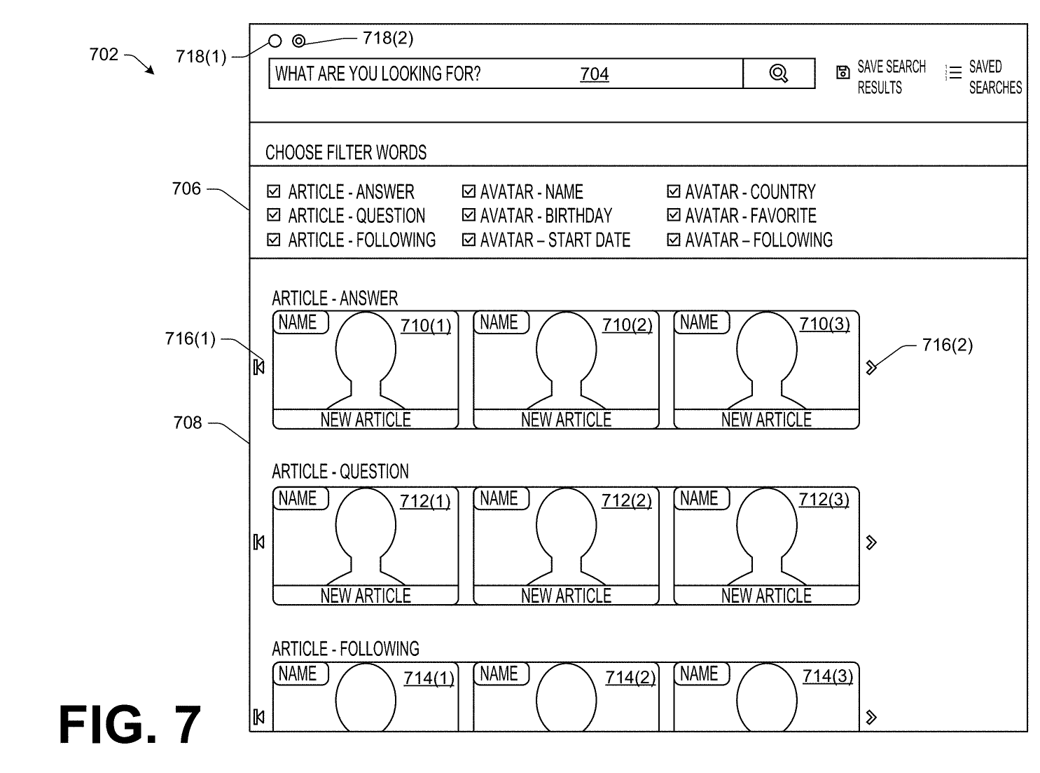

FIG. 7 illustrates a user interface 702 for searching for presentations 226 and/or user profiles. For instance, the user interface 702 includes a graphical element 704, such as a search bar, that the user can use to input one or more words for a search. The user interface 702 further includes a filtering portion 706, which includes graphical elements that are selectable to filter the search. For instance, and as illustrated in the example of FIG. 7, the user may filter the search by article answers, article questions, article followings, avatar names, avatar birthdays, avatar start dates, avatar countries, avatar favorites, and avatar followings. While these are just a couple of examples of filters that the user interface 702 may include, in other examples, the user interface 703 may not include one or more of the filters and/or the user interface 702 may include one or more additional filters.

As further illustrated in FIG. 7, the user interface 702 includes a results portion 708, which displays the results of the search. As shown, the results may be displayed according to the filters selected by the user. For instance, in the example of FIG. 7, the results include article answers, article questions, and article followings. Additionally, for article questions, the user interface 702 includes three results 710(1)-(3), for the articles questions, the user interface 702 includes three results 712(1)-(3), and for the articles following, the user interface 702 includes three results 714(1)-(4). As discussed herein, the results for each filter may be organized according to one or more factors.

In the example of FIG. 7, the user interface 702 further includes a graphical element 716(1) for viewing previous results and a graphical element 716(2) for viewing additional results. The user interface 702 includes similar graphical elements for each of the other filtered results (although not labelled for clarify reasons). Even though the user interface 702 is showing three results for each filter in the Example of FIG. 7, in other examples, the user interface 702 may display less results and/or more results.

As further illustrated in FIG. 7, the user interface 702 includes at least a first graphical element 718(1) and a second graphical element 718(2). In some instances, the first graphical element 718(1) may be selected to view a first set of filters and the second graphical element 718(2) may be selected to view a second set of filters, such as the filters shown in the filters portion 706. For instance, if the user selects the first graphical element 718(1), the remote system 102 may send, to the electronic device, data representing additional filters that the electronic device may display in the filter portion 706. While only two graphical elements 718(1)-(2) are illustrated in the example of FIG. 7, in other examples, the user interface 702 may include any number of graphical elements.

Although not illustrated in the example of FIG. 7, in some examples, the user interface 702 may allow the user to perform searches using a color bar (e.g., similar to the color bar 414). For example, the user interface 702 may allow the user to select a color from the color bar. The remote system 102 may then search for presentations and/or avatars that are associated with the selected color and send data representing the identified presentations and/or avatars to the electronic device. The electronic device may then display the presentations and/or avatars to the user, such as within the results portion 708.

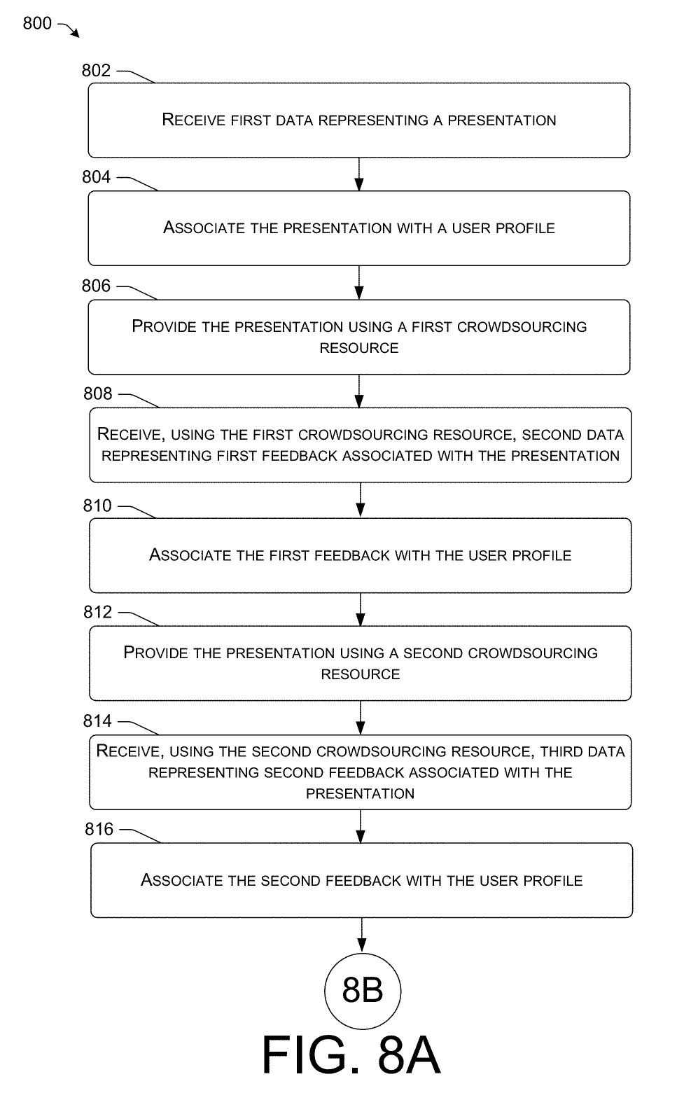

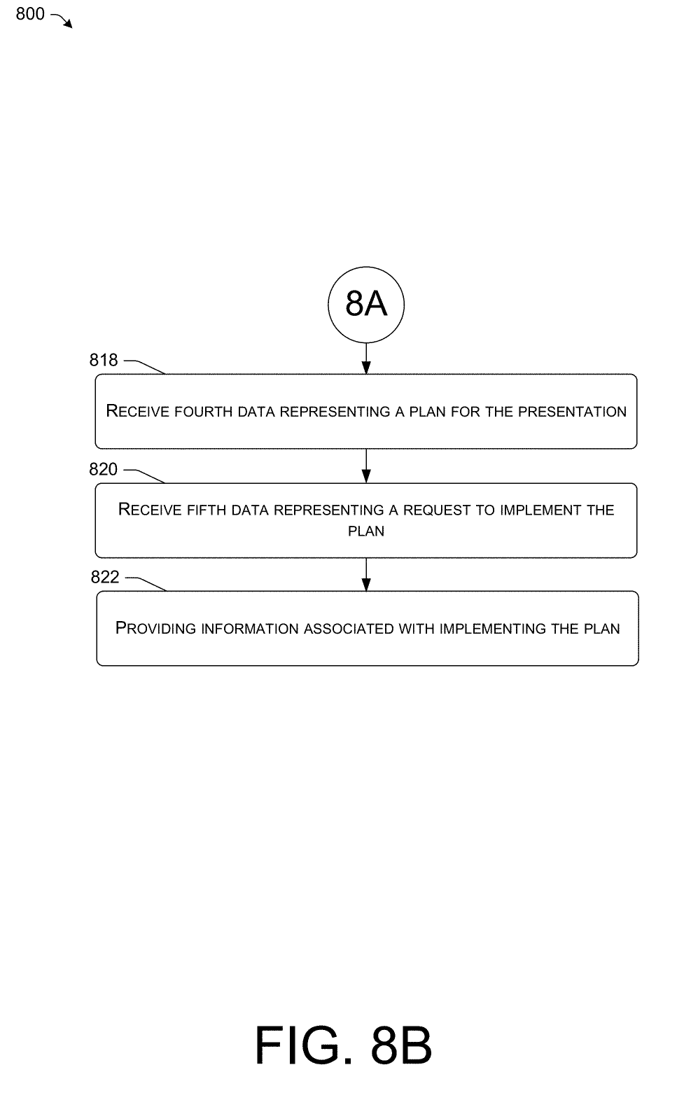

FIGS. 8A-10 illustrate various processes for using crowdsourcing resources in order to implement actions. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed.

FIGS. 8A-8B are an example process for utilizing crowdsourcing resources in order to implement an action. At 802, the process 800 may include receiving first data representing a presentation. For instance, the remote system 102 may receive, from an electronic device, the first data representing the presentation. The remote system 102 may then generate the presentation using the first data.

At 804, the process 800 may include associating the presentation with a user profile. For instance, the remote system 102 may associate the presentation with the user profile. In some instances, associating the presentation with the user profile may include storing data representing the presentation in association with the user profile. In some instances, the remote system 102 may further associate the presentation with an avatar. For instance, the remote system 102 may add the presentation to a network resource associated with the avatar.

At 806, the process 800 may include providing the presentation using a first crowdsourcing resource. For instance, the remote system 102 may provide the presentation using the first crowdsourcing resource. In some instances, providing the presentation using the first crowdsourcing resource may include adding the presentation to a network resource, such as a webpage, that allows other user(s) to provide feedback for the presentation. In some instances, the first crowdsourcing resource may be associated with “testing” the presentation using a first group of users. Still, in some instances, the first crowdsourcing resource may be associated with a particular first group of users. For example, the first crowdsourcing resource may be associated with user(s) located in a specific geographic area (e.g., zip code, city, state, etc.), user(s) that include a specific age range, user(s) that include similar interests (e.g., helping the environment, vehicles, sports, etc.), and/or the like.

At 808, the process 800 may include receiving, using the first crowdsourcing resource, second data representing first feedback associated with the presentation. For instance, while the presentation is being provided using the first crowdsourcing resource, the remote system 102 may receive, from electronic device(s), the second data representing the first feedback for the presentation. In some instances, the remote system 102 may then rate the presentation using the first feedback. Additionally, in some instances, the remote system 102 may provide the presentation using the first crowdsourcing resource according to the rating.

At 810, the process 800 may include associating the first feedback with the user profile. For instance, the remote system 102 may associate the first feedback with the user profile. In some instances, the remote system 102 may further provide the first feedback using the first crowdsourcing resource such that other user(s) can view the first feedback. In some instances, the remote system 102 may provide the first feedback according to ratings for the first feedback.

At 812, the process 800 may include providing the presentation using a second crowdsourcing resource. For instance, the remote system 102 may provide the presentation using the second crowdsourcing resource. In some instances, providing the presentation using the second crowdsourcing resource may include adding the presentation to a network resource, such as a webpage, that allows other user(s) to provide feedback for the presentation. In some instances, the user(s) may be included in a second group of users, which is different than the first group of users. Still, in some instances, the second crowdsourcing resource may be associated with a particular second group of users. For example, the second crowdsourcing resource may be associated with user(s) located in a specific geographic area (e.g., zip code, city, state, etc.), user(s) that include a specific age range, user(s) that include similar interests (e.g., helping the environment, vehicles, sports, etc.), and/or the like.

At 814, the process 800 may include receiving, using the second crowdsourcing resource, third data representing second feedback associated with the presentation. For instance, while the presentation is being provided using the second crowdsourcing resource, the remote system 102 may receive, from electronic device(s), the third data representing the second feedback for the presentation. In some instances, the remote system 102 may then rate the presentation using the second feedback. Additionally, in some instances, the remote system 102 may provide the presentation using the second crowdsourcing resource according to the rating.

At 816, the process 800 may include associating the second feedback with the user profile. For instance, the remote system 102 may associate the second feedback with the user profile. In some instances, the remote system 102 may further provide the second feedback using the second crowdsourcing resource such that other user(s) can view the second feedback. In some instances, the remote system 102 may provide the second feedback according to ratings for the second feedback.

At 818, the process 800 may include receiving fourth data representing a plan for the presentation. For instance, the remote system 102 may receive, from electronic device(s), the fourth data representing the plan for the presentation. In some instances, the plan may be associated with implementing one or more ideas included in the presentation. In some instances, the remote system 102 may then associate the plan with the user profile and/or the presentation.

At 820, the process 800 may include receiving fifth data representing a request to implement the plan. For instance, the remote system 102 may receive, from the electronic device associated with the user that created the plan, the fifth data representing the request to implement the plan.

AT 822, the process 800 may include providing information associated with implementing the plan. For instance, the remote system 102 may provide the information associated with implementing the plan. In some instances, providing the information may include the remote system 102 sending, to electronic device(s), data representing the information. Additionally, or alternatively, in some instances, providing the information may include the remote system 102 adding the information to a network resource that is viewable by other user(s).

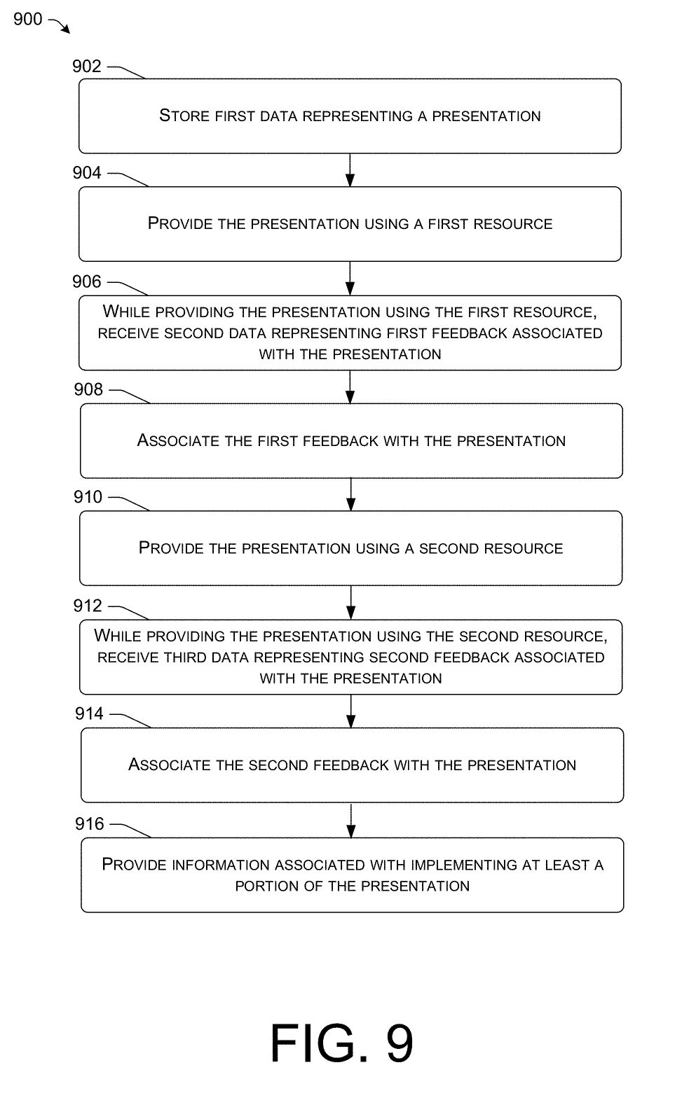

FIG. 9 is an example process 900 for utilizing multiple resources in order to generate and then implement at least one action included in a presentation. At 902, the process 800 may include storing first data representing a presentation. For instance, the remote system 102 may receive, from an electronic device, data representing the presentation. The remote system 102 may then generate the presentation using the data. After generating the presentation, the remote system 102 may store the first data representing the presentation. In some instances, the remote system 102 stores the first data in association with a user profile.

At 904, the process 900 may include providing the presentation using a first resource. For instance, the remote system 102 may provide the presentation using the first resource. In some instances, providing the presentation using the first resource may include adding the presentation to a network resource associated with a first crowdsourcing resource, such as a webpage associated with the first crowdsourcing resource, that allows other user(s) to provide feedback for the presentation. In some instances, the first resource may be associated with “testing” the presentation using a first group of users. Still, in some instances, the first resource may be associated with a particular first group of users. For example, the first resource may be associated with user(s) located in a specific geographic area (e.g., zip code, city, state, etc.), user(s) that include a specific age range, user(s) that include similar interests (e.g., helping the environment, vehicles, sports, etc.), and/or the like.

At 906, the process 900 may include, while providing the presentation using the first resource, receiving second data representing first feedback associated with the presentation. For instance, while the remote system 102 provides the presentation using the first resource, the remote system 102 may receive, from electronic device(s), the second data representing the first feedback for the presentation. In some instances, the remote system 102 may then rate the presentation using the first feedback. Additionally, in some instances, the remote system 102 may provide the presentation using the first crowdsourcing resource according to the rating.

At 908, the process 900 may include associating the first feedback with the presentation. For instance, the remote system 102 may associate the first feedback with the presentation and/or the user profile. In some instances, the remote system 102 may further provide the first feedback using the first resource such that other user(s) can view the first feedback. In some instances, the remote system 102 may provide the first feedback according to ratings for the first feedback.

At 910, the process 900 may include providing the presentation using a second resource. For instance, the remote system 102 may provide the presentation using the second resource. In some instances, providing the presentation using the second resource may include adding the presentation to a network resource associated with a second crowdsourcing resource, such as a webpage associated with the second crowdsourcing resource, that allows other user(s) to provide feedback for the presentation. In some instances, the user(s) may be included in a second group of users, which is different than the first group of users. Still, in some instances, the second resource may be associated with a particular second group of users. For example, the second resource may be associated with user(s) located in a specific geographic area (e.g., zip code, city, state, etc.), user(s) that include a specific age range, user(s) that include similar interests (e.g., helping the environment, vehicles, sports, etc.), and/or the like.

At 912, the process 900 may include while providing the presentation using the second resource, receiving third data representing second feedback associated with the presentation. For instance, while the remote system 102 is providing the presentation using the second resource, the remote system 102 may receive, from electronic device(s), the third data representing the second feedback for the presentation. In some instances, the remote system 102 may then rate the presentation using the second feedback. Additionally, in some instances, the remote system 102 may provide the presentation using the second resource according to the rating.

At 914, the process 900 may include associating the second feedback with the presentation. For instance, the remote system 102 may associate the second feedback with the presentation and/or the user profile. In some instances, the remote system 102 may further provide the second feedback using the second resource such that other user(s) can view the second feedback. In some instances, the remote system 102 may provide the second feedback according to ratings for the second feedback.

At 916, the process 900 may include providing information associated with implementing at least a portion of the presentation. For instance, the remote system 102 may provide the information associated with implementing the at least the portion of the presentation. In some instances, the information may include a plan for implementing an idea included in the presentation.

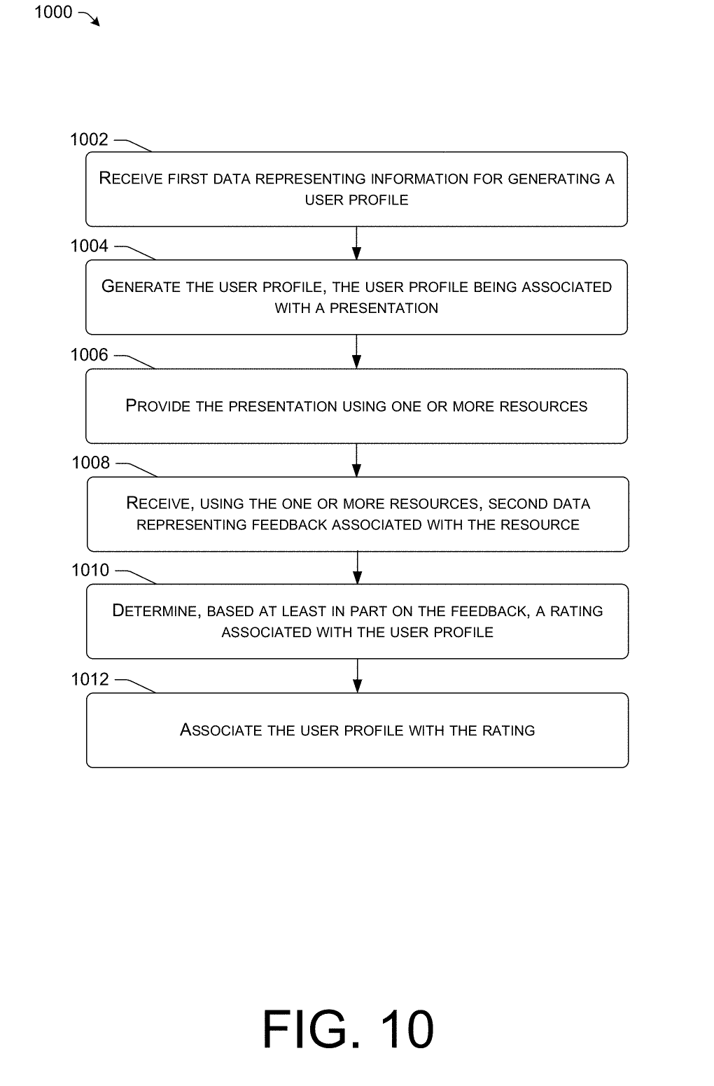

FIG. 10 is an example process 1000 for rating a user profile using feedback received via one or more resources. At 1002, the process 1000 may include receiving first data representing information for generating a user profile. For instance, the remote system 102 may receive, from an electronic device, the first data representing the information. As discussed herein, the information may include information associated with a user, information associated with an avatar, and/or information associated with a presentation.

At 1004, the process 1000 may include generating the user profile, the user profile being associated with a presentation. For instance, the remote system 102 may generate the user profile using the information. Additionally, the remote system 102 may generate the presentation using the information. The remote system 102 may then associate the presentation with the user profile. Furthermore, in some instances, the remote system 102 may generate the avatar using the information. The remote system 102 may then associate the avatar with the user profile and/or the presentation.

At 1006, the process 1000 may include providing the presentation using one or more resources. For instance, the remote system 102 may provide the presentation using the one or more resources. In some instances, the one or more resources may include at least a first crowdsourcing resource for receiving first feedback from a first group of users, a second crowdsourcing resource for receiving second feedback from a second group of users, and/or so forth. In some instances, the first crowdsourcing resource may be associated with a first type of membership and the second crowdsourcing resource may be associated with a second type of membership.

At 1008, the process 1000 may include receiving, using the one or more resources, second data representing feedback associated with the presentation. For instance, the remote system 102 may receive, from one or more computing devices, the second data representing the feedback. In some instances, the second data representing the feedback may include data representing first feedback received using the first crowdsourcing resource, data representing second feedback received using the second crowdsourcing resource, and/or so forth. In some instance, the remote system 102 may then associate the feedback with the user profile, the presentation, and/or the avatar.

At 1010, the process 1000 may include determining, based at least in part on the feedback, a rating associated with the user profile. For instance, the remote system 102 may determine the rating associated with the user profile based at least in part on the feedback. In some instance, the rating may be for the user profile, the presentation, and/or the avatar. In some instances, the remote system 102 may continue to determine new rating(s) as additional feedback is received.

At 1012, the process 1000 may include associating the user profile with the rating. For instance, the remote system 102 may associate the rating with the user profile. In some instances, associating the rating with the user profile may include associating the rating with the presentation and/or the avatar. In some instances, such as when the remote system 102 continues to determine new rating(s) as additional feedback is received, the remote system 102 may continue to associate the new rating(s) with the user profile.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. A system comprising:
one or more processors; and
one or more computer-readable media storing instructions that, when executed by the one or more processors, cause the one or more processors to perform operations comprising:
receiving, from a first electronic device, first data representing a presentation, the presentation being associated with a question and an answer to the problem;
associating the presentation with a user profile;
providing the presentation using a first crowdsourcing resource;
while providing the presentation using the first crowdsourcing resource, receiving, from a second electronic device, second data representing first feedback associated with the presentation;
associating the first feedback with the presentation;
providing the presentation using a second crowdsourcing resource;
while providing the presentation using the second crowdsourcing resource, receiving, from a third electronic device, third data representing second feedback associated with the presentation;
associating the second feedback with the presentation;
receiving from the first electronic device, fourth data representing a plan for solving the problem using the answer, the plan being based at least in part on at least one of the first feedback or the second feedback; and
providing information associated with implementing the plan.

2. The system as recited in claim 1, the one or more computer-readable media storing further instructions that, when executed by the one or more processors, cause the one or more processors to perform further operations comprising:
generating a group of users associated with the presentation,
wherein providing the informant associated with implementing the plan comprises providing, to the group of users, the information associated with implementing the plan.

3. The system as recited in claim 1, the one or more computer-readable media storing further instructions that, when executed by the one or more processors, cause the one or more processors to perform further operations comprising:
receiving, from the first electronic device, fifth data representing additional information for creating an avatar associated with the user profile;
creating the avatar using at least the additional information; and
associating the avatar with the presentation.

4. The system as recited in claim 1, the one or more computer-readable media storing further instructions that, when executed by the one or more processors, cause the one or more processors to perform further operations comprising:
determining that the user profile is associated with a first type of membership, wherein providing the presentation using the first crowdsourcing resource is based at least in part on the user profile being associated with the first type of membership; and
determining that the user profile is associated with a second type of membership, wherein providing the presentation using the second crowdsourcing resource is based at least in part on the user profile being associated with the second type of membership.

5. A method comprising:
storing first data representing a presentation;
providing the presentation using a first resource;
while providing the presentation using the first resource, receiving second data representing first feedback associated with the presentation;
associating the first feedback with the presentation;
providing the presentation using a second resource;
while providing the presentation using the second resource, receiving third data representing second feedback associated with the presentation;
associating the second feedback with the presentation; and
providing information associated with implementing at least a portion of the presentation.

6. The method as recited in claim 5, wherein:
providing the presentation using the first resource comprises providing the presentation using a first crowdsourcing resource that is accessible by a first group of users; and
providing the presentation using the second resource comprises providing the presentation using a second crowdsourcing resource that is accessible by a second group of members.

7. The method as recited in claim 5, further comprising:
generating a group of users associated with the presentation,
wherein providing the information associated with implementing the at least the portion of the presentation comprises providing, to the group of users, the information associated with implementing the at least the portion of the presentation.

8. The method as recited in claim 5, further comprising:
receiving fourth data representing additional information for creating an avatar associated with the user profile;
creating the avatar using at least the additional information; and
associating the avatar with the presentation.

9. The method as recited in claim 5, further comprising:
determining that the user profile is associated with a first type of membership, wherein providing the presentation using the first resource is based at least in part on the user profile being associated with the first type of membership; and
determining that the user profile is associated with a second type of membership, wherein providing the presentation using the second resource is based at least in part on the user profile being associated with the second type of membership.

10. The method as recited in claim 5, wherein the presentation is associated with a question, and wherein the method further comprises:
receiving fourth data representing a plan associated with an answer for the question; and
generating the information based at least in part on the plan.

11. The method as recited in claim 5, further comprising:
providing a plurality of presentations using the second resource;
determining, using at least the second feedback, a rating associated with the presentation; and
determining a position for the presentation within the plurality of presentations based at least in part on the rating,
wherein providing the presentation using the second resource is based at least in part on the position.

12. The method as recited in claim 5, further comprising:
determining one or more tags associated with the presentation;
sending, to an electronic device, fourth data representing the second resource, the second resource including a graphical element for searching for presentations;
receiving, from the electronic device, fifth data representing a query, the query including one or more words; and
determining that a word from the one or more words is associated with a tag from the one or more tags,
wherein providing the presenting using the second resource comprises sending, to the electronic device, sixth data representing the presentation.

13. The method as recited in claim 5, wherein the presentation is associated with a question and a first answer, and wherein the method further comprises:
receiving fourth data representing a second answer to the question;
receiving fifth data representing third feedback associated with the second answer;
determining, based at least in part on at least one of the first feedback or the second feedback, a first rating associated with the first answer;
determining, based at least in part on the third feedback, a second rating associated with the second answer;
determining that the second rating is greater than the first rating; and
providing the first answer and the second answer based at least in part on the second rating being greater than the first rating.

14. The method as recited in claim 5, further comprising:
receiving fourth data representing an update to the presentation; and
generating an updated presentation by updating the presentation using the fourth data,
wherein providing the presentation using the second resource comprises providing the updated presentation using the second resource.

15. The method as recited in claim 5, further comprising generating the information using at least one of the first feedback or the second feedback.

16. A system comprising:
one or more processors; and
one or more computer-readable media storing instructions that, when executed by the one or more processors, cause the one or more processors to perform operations comprising:
generating a presentation associated with a user profile;
sending, to a first electronic device via a first resource, first data representing the presentation;
receiving, from the first electronic device, second data representing first feedback associated with the presentation;
sending, to a second electronic device via a second resource, third data representing the presentation;
receiving, from the second electronic device, fourth data representing second feedback associated with the presentation; and
providing information associated with an idea included in the presentation.

17. The system as recited in claim 16, wherein:
the first resource includes a first crowdsourcing resource that is accessible by a first group of members; and
the second resource includes a second crowdsourcing resource that is accessible by a second group of members.

18. The system as recited in claim 16, the one or more computer-readable media storing further instructions that, when executed by the one or more processors, cause the one or more processors to perform further operations comprising:
generating a group of users associated with the presentation,
wherein providing the information associated with an idea included in the presentation comprises providing, to the group of users, the information associated with the idea included in the presentation.

19. The system, as recited in claim 16, the one or more computer-readable media storing further instructions that, when executed by the one or more processors, cause the one or more processors to perform further operations comprising:
receiving fifth data representing additional information for creating an avatar associated with the user profile;
creating the avatar using at least the additional information; and
associating the avatar with the presentation.

20. The system as recited in claim 16, wherein the presentation is associated with a question, and wherein the one or more computer-readable media store further instructions that, when executed by the one or more processors, cause the one or more processors to perform further operations comprising:
receiving fifth data representing a plan for solving the problem; and
generating the information based at least in part on the plan.
